(19) United States
(12) Patent Application Publication
(10) Pub. No.: US 2025/0020320 A1
(43) Pub. Date: Jan. 16, 2025

(54) STRUCTURES FOR SOLAR VAPOR EVAPORATION AND CONDENSATION

(71) Applicant: The Research Foundation for The State University of New York, Amherst, NY (US)

(72) Inventors: Qiaoqiang GAN, East Amherst, NY (US); Lyu ZHOU, Amherst, NY (US)

(21) Appl. No.: 18/711,863

(22) PCT Filed: Nov. 21, 2022
(86) PCT No.: PCT/US22/80280

§ 371 Date: May 20, 2024

Related U.S. Application Data
(60) Provisional application No. 63/281,617, filed on Nov. 19, 2021.

(51) Int. Cl. F22B 1/00; B01D 1/00; B01D 5/00; C02F 1/04; C02F 1/14; C02F 103/08; F24S 20/30

(52) U.S. Cl. CPC F22B 1/006; B01D 1/0035; B01D 5/006; C02F 1/048; C02F 1/14; F24S 20/30; C02F 2103/08

(57) ABSTRACT

A solar vapor generation system includes a substrate configured to wick solution from a reservoir. The substrate includes a first planar sheet having a first end, and a second planar sheet having a first end. The first end of the first planar sheet is connected to the first end of the second planar sheet at an angle of less than 180.0 degrees. In some embodiments, the angle is less than 90.0 degrees. At least a portion of the first planar sheet is configured to be in contact with the solution. The system includes a support, configured to support the substrate at a position near a surface of the solution.

### CROSS-REFERENCE TO RELATED APPLICATIONS

This application claims priority to U.S. Provisional Application No. 63/281,617, filed on Nov. 19, 2021, now pending, the disclosure of which is incorporated herein by reference.

### STATEMENT REGARDING FEDERALLY SPONSORED RESEARCH

This invention was made with government support under contract no. W913E5-20-C-0009 awarded by the U.S. Army Research Office and under grant no. 1932968 awarded by the National Science Foundation. The government has certain rights in the invention.

### FIELD OF THE DISCLOSURE

The present disclosure relates to solar vapor generation, and more particularly to solar vapor evaporation and condensation.

### BACKGROUND OF THE DISCLOSURE

The advent of the steam engine was one of the key developments that led to the first Industrial Revolution. Since then, the use of steam has influenced many aspects of modern life. For instance, thermal steam generation and condensation was one of the dominant technologies for seawater desalination before the introduction of reverse osmosis technologies. Although membrane-based technologies became the dominant solution to desalination, they are usually energetically demanding with serious environmental impacts arising from cleaning and maintenance. As a result, there is emerging global interest in developing alternative desalination technologies to address these issues. Solar vapor generation with no electrical input is proving to be a promising and environmentally benign solution, especially in resource limited areas. However, conventional techniques for generating solar vapor typically rely on costly and cumbersome optical concentration systems to enable bulk heating of a liquid, resulting in relatively low efficiencies (e.g., 30%-40%) due to heat absorption throughout the entire liquid volume that is not directly translated into vapor production. Recently, various advanced and expensive metallic plasmonic and carbon-based nanomaterials have been explored for use in solar vapor/steam generation. However, the vaporization efficiencies of these reported structures are still relatively low under 1 sun illumination (e.g., 48% (10)˜83%).

For practical outdoor solar still applications, stable and continuous solar illumination is not achievable in most areas of this planet due to varying weather conditions. Even with inexpensive moderate solar concentrators, a stable incident power higher than AM 1.5 solar light still cannot be guaranteed. Additionally, since most solar stills are covered by glass or other similar collection material, condensation can lead to optical scattering and a decrease in the incident solar power. Therefore, vapor generation under <1 solar illumination condition is an important, long-felt need, despite being neglected in most previously reported work.

### BRIEF SUMMARY OF THE DISCLOSURE

The present disclosure provides an alternative approach to solar vapor generation using a supported substrate. In an extremely cost-efficient and effective embodiment, the substrate is a carbon black-dyed cellulose-polyester blend (CCP) and the support is expanded polystyrene foam (EPS). A system according to some embodiments of the disclosed technology achieved a record thermal conversion efficiency of ˜88% under non-concentrated solar illumination of 1 kW/m². This corresponds to an optimized vapor generation rate that is ˜3 times greater than that of natural evaporation. Stable and repeated seawater desalination tests were performed in a portable prototype both in the laboratory and an outdoor environment, and achieved a water generation rate that was 2.4 times that of a commercial product. Also, desalination systems according to some embodiments of the present disclosure largely avoid the costs for seawater intake and pretreatment that are generally required for conventional reverse osmosis processes. Compared with previously reported advanced nanostructures, this CP-EPS system is extremely low-cost in terms of both materials and fabrication, environmentally benign, and safe to handle during production. These attributes enable such a system to be easily expanded to a large scale system. Furthermore, embodiments of the present system may be used for simultaneous fresh water generation and treatment from heavily contaminated source water. Membrane filters and photocatalysts may also be incorporated to purify contaminated source water. Considering the challenges in contaminated/waste water treatment and reuse, the development of low cost, electricity-free, and multi-functional technologies represents a significant advance in the field.

In some embodiments, the approach further utilizes cold vapor below room temperature, and provides a near unity conversion efficiency of absorbed solar energy. Due to the energy contribution from the surroundings, the measured total vapor generation is higher than the upper limit that can be produced by a given incident solar energy. Importantly, this breakthrough technique was realized using the extremely low cost CCP-foam system under 1 sun illumination, with no need for advanced and expensive nanomaterials. In addition, features for optically absorbing and evaporative materials for solar still systems are shown: i.e., under a given environment, a stronger natural evaporation capability will result in a lower surface temperature. This provides applications in solar still technology, evaporative cooling and solar evaporated mining applications, evaporation-driven generators and recently reported water-evaporation-induced electricity.

### DESCRIPTION OF THE DRAWINGS

For a fuller understanding of the nature and objects of the disclosure, reference should be made to the following detailed description taken in conjunction with the accompanying drawings, in which:

FIG. 1 depicts the physical mechanism of vapor generation. (A) Energy balance and heat transfer diagram of the CCP-foam under strong solar illumination. The surface temperature, T₂, is higher than the room (ambient) temperature, T₁. (B) A photograph of CCP-foam floating on top of water surface and its corresponding thermal image under dark environment—the surface temperature is below room temperature. (C) Energy balance and heat transfer diagram of the CCP-foam under dark environment or low intensity illumination. (D) A photograph of a CCP-air gap-foam structure floating on top of water and its corresponding thermal image under dark environment—the surface temperature is even lower than the CCP-foam structure.

FIG. 2 shows vapor generation under low density light illumination. (A) Photographs of a CCP-foam (upper panel) and a CCP-air gap-foam (lower panel) under 0.6 sun illumination. (B) Thermal images of the CCP-foam (upper panel) and the CCP-air gap-foam (lower panel) under 0.6 sun illumination. (C) Comparison of measured water weight change versus time of CCP-foam and CCP-air gap-foam. The upper limit that can be produced by 0.6 sun input solar energy is plotted by the solid curve. (D) Thermal images of the CCP-foam (upper panel) and the CCP-air gap-foam (lower panel) under 0.2 sun illumination. (E) Comparison of measured water weight change versus time of CCP-foam and CCP-air gap-foam. The upper limit that can be produced by 0.2 sun input solar energy is plotted by the solid curve.

FIG. 3 shows the physical interpretation of energy balance of solar vapor generation systems. (A) Energy flow diagram under dark conditions: the input energy from the environment is in balance with the evaporation energy. (B) Energy flow diagram of a below-room-temperature system with a weak light input: the output evaporation energy is the sum of the light input and the environment input. (C) Energy flow diagram of a room-temperature system: the output evaporation energy is in balance with the surrounding and light input. (D) Energy flow diagram of a hot system: the input solar energy is the sum of the evaporation energy and the loss to the environment.

FIGS. 4A and 4B show the increased surface area under 1 sun illumination. (4A(A)) Exemplary schematic diagram to reduce the light density by introducing larger surface area structures. (4A(B), 4A(D)-4A(E)) Thermal distribution images and corresponding photographs of three exemplary samples (4A(B)) a flat CCP-foam, (4A(D)) a triangle structure with θ of 37.8°, (4A(E)) a triangle structure with θ of 22.90. (4B(C)) Comparison of measured water weight change versus time of the three exemplary CCP-foam samples (spheres)—wherein the calculated upper limits that can be produced by 1 sun input solar energy are plotted by solid curves. (4A(F)-4A(G)) The thermal distribution images and corresponding photographs of CCP-air gap-foam structures with (4A(F)) θ=37.40 and (4A(G)) θ=22.40. (4B(H)) Comparison of measured water weight change versus time of these two CCP-air gap-foam samples (spheres)—wherein the calculated upper limits that can be produced by 1 sun input solar energy are plotted by solid curves.

FIG. 5A shows the configuration of a water diffusion height experiment for three sample substrates: white substrate (left); CCP (center); sodium alginate treated CCP (right).

FIG. 5B is a thermal image of the three sample substrates of FIG. 5A showing the resulting water diffusion heights.

FIG. 6 shows the optical absorption spectrum of the CCP and the transmission spectrum of the diffuser. The absorption is ˜96.9% by weighting absorption spectrum (topmost curve) with the AM 1.5 solar irradiance, which contributes to a high efficiency. The shaded area shows the solar irradiation spectrum as a reference. The transmission spectrum (middle curve) indicates that the transmitted light by the diffuser will basically keep the energy distribution of AM 1.5 at different wavelengths.

FIG. 7 shows an experimental setup for solar vapor generation. CCP-foam is illuminated using the solar simulator.

FIG. 8 shows an apparatus used to characterize dark evaporation in controlled environment (a commercial glove box is 61 cm×46 cm×38 cm with controlled relative humidity and temperature inside the box).

FIG. 9 is an illustration of an embodiment of a solar evaporator module floating on top of water surface, wherein each module contains an electricity/solar-driven fan to accelerate the convection.

FIG. 10 shows an embodiment of the presently-disclosed carbon substrate in a NaCl brine under 1 sun illumination with a picture being recorded every 30 minutes. One can see the salt crystal accumulated on top of the black substrate surface, which will decrease the vapor evaporation rate. Intriguingly, the salt crystals tended to accumulate on the substrate surface (up to image 10), which may simplify the collection of salt in practice.

FIG. 11 shows the mass change over time of the sample under 1 sun illumination. Notice that as salt builds up on our material, only a slight decrease in performance is observed (up to image 10). Therefore, the performance of the salt collector should be very stable and can be replaced easily. Moreover, when the solar simulator is turned off after 8-hour illumination, the salt will be dissolved from the CCP surface back into the bulk water, demonstrating the minimum maintenance requirements.

FIGS. 12A and 12B show a preliminary experiment in an outdoor environment. Each container has 450 ml water with 40 gram salt. After 10 hour test (FIG. 12B), obvious salt can be obtained from the carbon substrate surface (left container) while the control sample did not have any output (right container). Therefore, the presently-disclosed strategy can be used for a solar mining using low concentration solution. At least 8 grams of salt were obtained from the carbon substrate surface in the experiment.

FIG. 13 depicts a system according to another embodiment of the present disclosure.

FIG. 14(A) Scanning Electron Microscope (SEM) image of uncoated fiber-rich paper. (B) SEM image of CCP under low and high magnifications (inset). (C) Top line: Absorption spectra of uncoated white paper; Bottom line: Absorption spectra of CCP. Absorption spectra were measured by an integration sphere; Inset: Photograph of these two pieces of paper. (D) Comparison of water weight change versus time under four different conditions: i) water in dark environment; ii) water under 1 kW/m² illumination; iii) floating white paper under 1 kW/m² illumination and iv) floating CCP under 1 kW/m² illumination. (E) The surface temperature distribution of the four samples measured in FIG. 14(D) measured using a thermal imager: the upper left panel corresponds to i) of FIG. 14(D); the upper right panel corresponds to ii) of FIG. 14(D); the lower left panel corresponds to iii) of FIG. 14(D) and the lower right panel corresponds to iv) of FIG. 14(D).

FIG. 15A Photographs of a CCP with (upper panel) and without the insulating EPS foam (lower panel) floating on top of water.

FIG. 15B Photograph of the CCP-foam structure with cover foam to eliminate evaporation from the water surface surrounding the CCP-foam structure.

FIG. 15C Comparison of water mass change due to evaporation versus time under four different conditions: water under 1 kW/m², exfoliated graphite on foam from previous work, CCP without insulating foam, and CCP with insulating foam.

FIG. 15D Surface temperature distribution of an exemplary CCP with (upper panel) and without the insulating EPS foam (lower panel) floating on the water.

FIG. 16(A) The water mass change as a function of time under 1, 3, 5, 7 and 10 times concentrated solar illumination, respectively. (B) The temperature change as a function of time under 1, 3, 5, 7 and 10 times concentrated solar illumination, respectively. The solid lines represent vapor temperatures measured by a thermometer installed above the CCP-foam. The dashed lines represent bulk water temperatures measured under the foam, while the lines are as for FIG. 16(A). (C) The solar thermal conversion efficiency (light gray dots) and corresponding evaporation rate (black dots) as a function of solar intensity. (D) Direct comparison of solar thermal conversion efficiencies obtained by previously reported structures and an exemplary CCP-foam according to an embodiment of the present disclosure.

FIG. 17(A) Energy balance and heat transfer diagram in an exemplary CCP-foam architecture during the vapor generation process. (B) Diagram of the detail near the surface of the CCP structure during the vapor generation process.

FIG. 18(A) Evaporation rate of exemplary CCP-foam samples on salt water and pure water as the function of cycle number. The two solid lines are reference lines to show the stable performance. (B) An SEM image of an exemplary CCP sample after 1 hour evaporation in salt water. (C) Evaporation rate of CCP sample in salt water over an 8-hour evaporation period as a function of illumination time. (D) Photographs and (E) thermal images of an exemplary CCP-foam on salt water at times corresponding to the evaporation rate of salt water in FIG. 17(C).

FIG. 19A (A) Schematic illustration of a conventional desalination solar still. (B) Photograph of a 5×5 CCP array with a total area of 100 cm² according to an embodiment of the present disclosure. (C) and (D) are thermal images of the CCP array before (C) and after (D) solar illumination. (E-G) Photographs of experimental systems with (E) a CCP-foam array on salt water, (F) bare salt water with a layer of black aluminum foil placed at the bottom, and (G) bare salt water with no CCP-foam. (I) The photograph of a prototype system placed outdoors on a lake. (J) The photograph of a control experiment with a commercial product (left) and the exemplary system (right) during the experiment. Condensation can be seen at the inner surfaces of the covers.

FIG. 19B (H) Hourly water weight change with the exemplary CCP-foam array on the water surface (dots), black aluminum foil at the bottom (triangles), and salt water (squares) as a function of illumination time; the top dashed line is the hourly bulk water temperature under CCP foam; middle dashed line is the hourly bulk water temperature with the black aluminum foil at the bottom of the container; bottom dashed line is the hourly water weight change of salt water. (K) The solar intensity (upper panel) and outdoor temperature curves (lower panel) from 8:00 am to 6:00 pm on May 6, 2016.

FIG. 20(A) Comparison of the water solution used to ultrasonically clean a CCP sample after different amounts of time. (B) Photographs of the CCP sample after different amounts of ultrasonic cleaning time. (C) Optical absorption spectra of the CCP sample after ultrasonic cleaning.

FIG. 21(A) Surface temperature distribution of a black Al foil (left) and a CCP sample (right) placed on top of a heat plate set at 40° C. (B) Direct measurement of the temperature at three positions using a thermal couple sensor probe.

FIG. 22 Photographs of an experimental setup to measure the temperature of (A) vapor and (B) bulk water.

FIG. 23 Optical absorption spectrum of a black Al foil measured by an integration sphere. Inset: the photograph of a black Al foil.

FIG. 24 is a diagram depicting another embodiment of the present disclosure.

FIG. 25 is a diagram depicting another embodiment of the present disclosure.

FIG. 26A is a diagram depicting a solar vapor generator according to another embodiment of the disclosure.

FIG. 26B is a detail view of the portion of FIG. 26A depicted with a dashed border, and wherein FIG. 26B shows an alternative embodiment of contact with the solution.

FIG. 27 is a diagram depicting a solar vapor generator according to another embodiment of the disclosure;

FIG. 28 is a diagram depicting a solar vapor generator according to another embodiment of the disclosure;

FIG. 29A is a side view of an exemplary solar still according to an embodiment of the present disclosure.

FIG. 29B is a top view diagram of the solar still of FIG. 29A.

FIG. 29C is a photograph of the exemplary solar still constructed according to FIGS. 29A and 29B.

FIG. 30 is a diagram of an exemplary floating CCP-foam with air gap for thermal isolation (side view).

FIG. 31 is a chart depicting another embodiment of the present disclosure.

FIG. 32: The umbrella architecture for enhanced solar evaporation. (a) Schematic illustration of salt crystallization based on water delivery direction on a flat system. (b) Schematic illustration of a tapered architecture. (c) Schematic illustration of an “umbrella” structure. The water flow directions in these three architectures are indicated by the white arrows. (d) Optical absorption spectrum of the black surface for water evaporation (upper inset: hydrophilic feature of the fabric materials used as the evaporation surfaces; lower inset: SEM image of the fabric. Scale bar: 200 μm). (e) Photos and thermal images of the flat sample (upper panel) and the “umbrella” structure (lower panel) under 1 sun illumination. (f) Mass change of the three structures over 8 hours using fresh water under 1 sun illumination.

FIG. 33: Self-cleaning evaporative architecture. (a-c) Comparison of the three structures (i.e., the first column: top-view of the flat structure, the second column: side-view of the 1-layer structure, and the third column: side-view of the 12-layer structure) after 10 hours of operation under 1 sun illumination with the salinity of (a) 3.5 wt %, (b) 7 wt %, and (c) 10 wt %, respectively. (d) Measured evaporation rates under 1 sun illumination. Insets: Architecture of the flat (the lower panel), 1-layer (the central panel) and 12-layer structures (the upper panel).

FIG. 34: Water transfer capability. (a) Characterization of salt accumulation on the umbrella structure. (b) Comparison of materials (carbon coated paper, filter paper, and Highland fabric as described below) to determine maximum Q_{c}. (c) Thermal images of the 1-layer evaporation surface (the left panel) and the dry surface (the right panel) under the same solar under 4 sun illumination. (d) Measured ratio of Lₛ/\dot{m} (dark spheres) and \dot{m} (light spheres) as the function of the evaporative film thickness Lₛ. The dashed line is the fitting curve to show the trend of Qₑ with the increasing Lₛ.

FIG. 35: Experimental results for salinity of 20 wt % (a) Measured evaporation rates of 4-day indoor experiment under 1 sun illumination. Inset: photos of the umbrella structure on each day. (b-c) SEM images of the accumulated salt on (b) the CCF and (c) the Highland fabric, respectively. (d) A photo of the outdoor experiment on Aug. 3, 2021 at the University at Buffalo. (e) Measured environmental conditions for the outdoor experiment (from top to bottom): the relative humidity (RH), the temperature, the solar intensity (SI), and the wind velocity. (f) Measured evaporation rates of the umbrella structure (dark gray), the flat structure (light gray), and the bulk water surface (black), respectively. (g) Photos of the salt accumulation after the 4-day operation on the umbrella structure (the upper panel), the flat structure (the central panel), and the bottom of the container (the lower panel).

FIG. 36: (a) Salt accumulation on the tapered architecture shown in FIG. 32b. (b) Thermal images of the structure under 1 sun illumination. (c) A chart showing mass change of the tapered structure.

FIG. 37: Side-view photos of the three architectures in FIGS. 32a-c: (a) the flat, (b) the tapered triangle, and (c) the umbrella evaporation system, respectively.

FIG. 38: is a chart of the measured evaporation rates of structure a, structure b, and structure c of FIG. 39, respectively.

FIG. 39: (a-d) Photos of the structures (a) tapered structure (structure a), (b) tapered structure with one side in reservoir (structure b) (photo is of Wing I—contacting reservoir), (c) tapered structure with one side in reservoir (structure b) (photo is of Wing II—not in contact with reservoir), and (d) umbrella structure (structure c). (e) Measured salt occupancies of structures a (left dot), b (two middle dots), and c (right dot), respectively. Inset: The definitions of Wing I and Wing II for structure b.

FIG. 40: Carbon density (dark spheres) and the water transportation rate (white circles) of the carbon coated paper using different amount of carbon powders.

FIG. 41: Measured evaporation rates of umbrella structures with different parameters. Inset: the definitions of the structure parameters.

FIG. 42: Photos and thermal images of umbrella structures with different parameters.

FIG. 43: (a-d) Photos and thermal images of umbrella structures with different parameters. (e) Measured evaporation rates and salt occupancies of the umbrella structures in (a-d).

### DETAILED DESCRIPTION OF THE DISCLOSURE

Unless defined otherwise herein, all technical and scientific terms used in this disclosure have the same meaning as commonly understood by one of ordinary skill in the art to which this disclosure pertains. The disclosure includes all combinations of all components and steps described herein. Throughout this application, the singular form includes the plural form and vice versa.

By utilizing extremely low-cost materials in this invention, economically viable large-area systems are now possible with no energy input required for operation. This prospect is particularly attractive for addressing global freshwater shortages, especially for individuals to purify water for personal needs (i.e., ˜2 liter/day) in developing regions. Because embodiments of the present disclosure do require special micro/nanofabrication processes and do not require solar concentrators, the disclosed technology is extremely low-cost and amenable to scaling up over large or huge areas for real applications.

Without being bound by any theory, due to the superior absorption, heat conversion, and insulating properties of the presently-disclosed CCP-foam structure, most of the absorbed energy can be used to evaporate surface water with significantly reduced thermal dissipation compared with previously reported architectures. Without being bound by any theory, due to the thermal insulation between the surface liquid and the bulk volume of the water and the suppressed radiative and convective losses from the absorber surface to the adjacent heated vapor, a record solar thermal conversion efficiency of >88% under illumination of 1 kW/m² (corresponding to the evaporation rate of 1.28 kg/(m²·h)) was realized using an embodiment of the disclosure having no solar concentration. When scaled up to a 100 cm² array in a portable solar water still system, the outdoor fresh water generation rate was 2.4 times of that of a leading commercial product. Furthermore, seawater desalination was also demonstrated with reusable stable performance.

To enhance the vapor generation rate, typically the approach is to increase the operation temperature for a given solar illumination. However, this will inevitably increase the thermal loss to the surroundings mainly via conduction, convection and radiation losses. Therefore, high temperature solar vapor generation (e.g., with solar concentration) inherently suffers from limits in energy conversion efficiencies.

In some embodiments, present disclosure provides techniques which take an opposite approach, using solar energy to generate cold vapor below room temperature, to provide surprising results. This is a breakthrough pathway for efficient solar vapor generation since under illumination at low power densities, the absorbed-light-to-vapor energy conversion efficiency can reach ˜100% when the evaporation temperature is lower than the room temperature. Under this condition, the environment will provide additional energy for vapor generation, resulting in a total vaporization rate that is higher than the upper limit that can be produced using the input solar energy alone. This cold vapor generation technique was experimentally validated and demonstrated limit-breaking vaporization rates using an extremely low cost CCP-foam system.

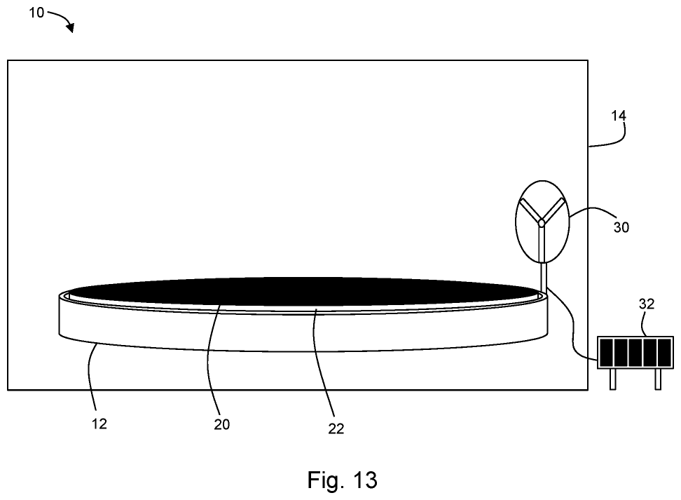

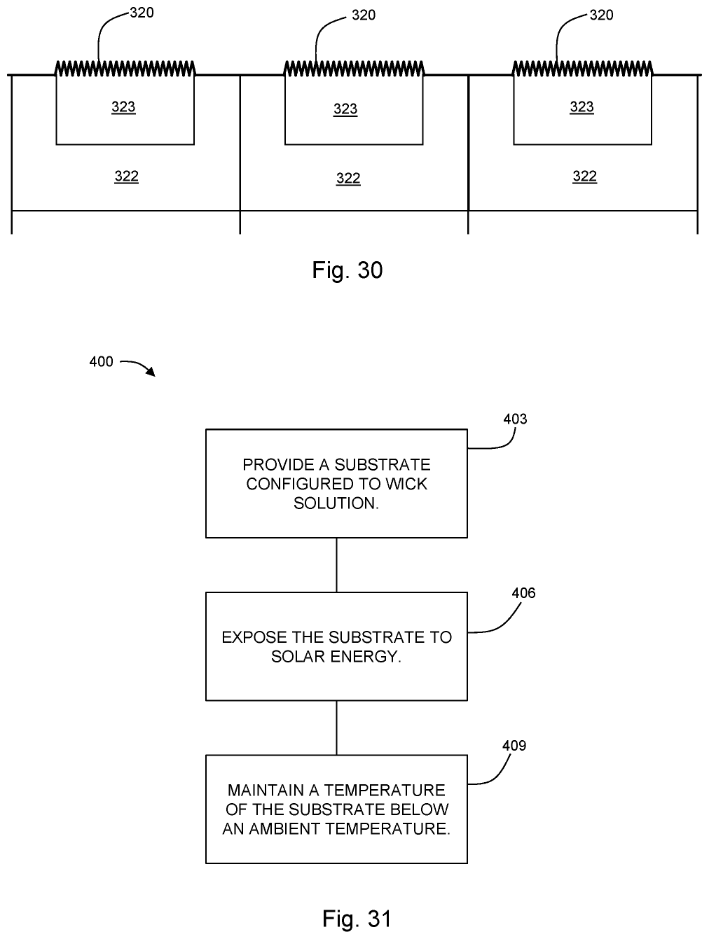

With reference to FIG. 13, in a first aspect, the present disclosure may be embodied as a solar vapor generation system 10 having an open-topped vessel 12 for holding a solution, for example, a water-based solution. A substrate 20 is configured to be placed in the open-topped vessel 20. The substrate 20 is configured to wick solution from the vessel 12. The substrate 20 may be supported above the solution (e.g., above a surface of the solution, near the surface of the solution) by a support 22. The support may have a density less than water. The support 22 may be thermally insulative and/or thermally stable. The support 22 may be a foam. The support 22 may be configured to not absorb water. The support 22 may comprise expanded polystyrene foam (EPS), polyurethane foam, polyvinyl chloride foam, polyethylene form, a phenol formaldehyde resin foam, or other foam materials or combinations of one or more materials. The support 22 may include an air gap, to separate at least a portion of the substrate 20 from the support 22 allowing air to pass between a portion of the support 22 and the substrate 20 (see, e.g., FIG. 30).

The system 10 may further comprise a housing 14. The substrate 20 and the support 22 may be located within the housing 14. In some embodiments, at least a portion of the vessel 12 may be located within the housing 14. The housing 14 may be configured so as to admit solar energy. For example, the housing 14 may have a transparent top. For example, the housing 14, or a portion thereof, may be made from a transparent plastic, a transparent glass, a transparent polymer membrane (e.g., microwave membrane), etc. In some embodiments, an interior surface of the cover is coated with a non-toxic, anti-mist super-hydrophobic surface treatment.

The system 10 may further comprise an air mover 30 configured to cause air (e.g., ambient air) to move adjacent to the substrate 20. The air mover 30 may be an electrically-powered fan 30, which may be powered by way of, for example, a solar cell 32.

In some embodiments, a temperature of the substrate 20 is maintained substantially at or below an ambient temperature. For example, in embodiments having a housing 14, the housing may be a temperature-controlled housing 14 for maintaining an ambient temperature above the temperature of the substrate 20. By maintaining a temperature substantially at an ambient temperature, it is intended that the temperature of the substrate be maintained to within 5° C. of the ambient temperature. In some embodiments, substantially at the ambient temperature means to maintain the temperature to within 1, 2, 3, or 4° C. or any other value therebetween to within a decimal position. In some embodiments, the substrate is maintained at a temperature below the ambient temperature.

In some embodiments, the system 10 is used as a solar still. For example, in such embodiments, the system 10 may be used to desalinate water for use as drinking water. In such embodiments, the system 10 may further comprise a condenser for condensing the generated vapor. For example, the housing 14 may be configured such that vapor condenses on the housing 14 (i.e., an inner surface of the housing) for recovery of the condensate. In other embodiments, a condenser, such as a condensation trap, may be located within the housing or outside of the housing.

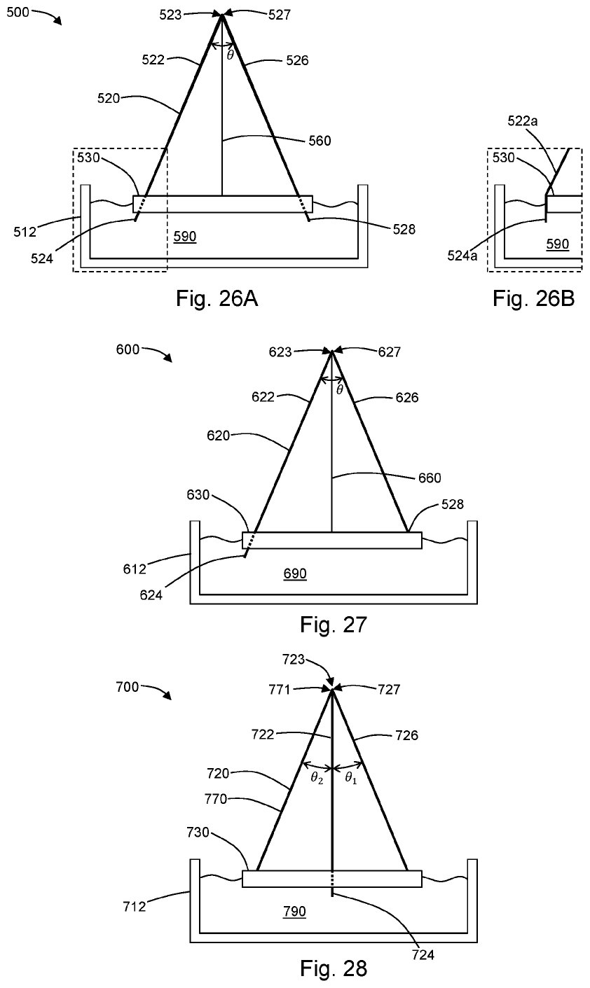

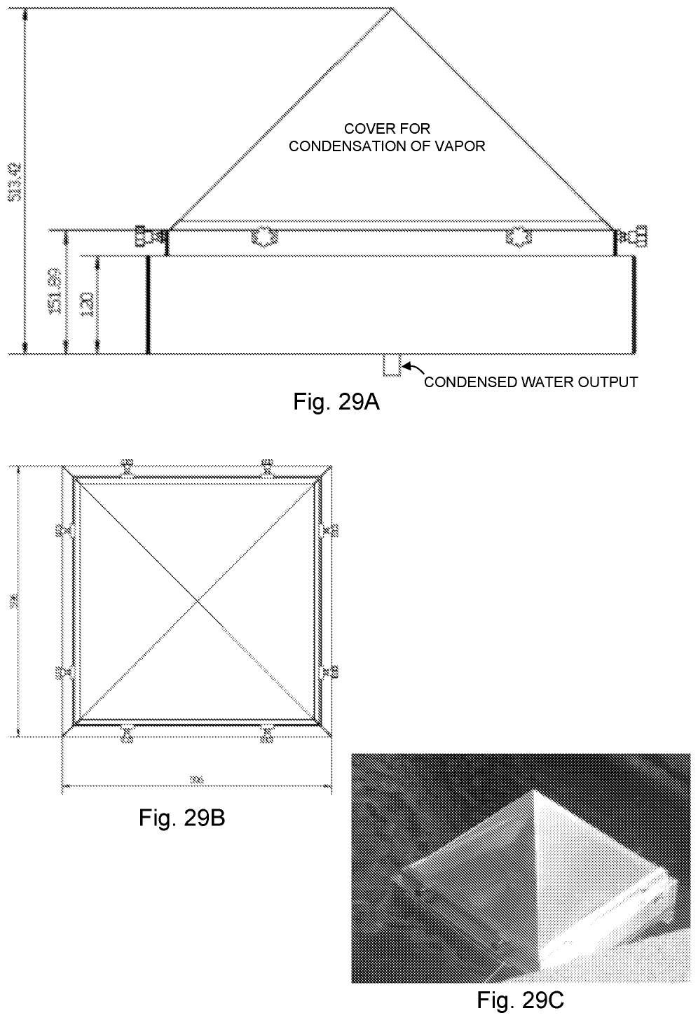

As will be further described below under the heading “Further Discussion,” the substrate 20 may be configured as a planar sheet generally parallel to a top surface of the solution. In another embodiment, the substrate is tent-shaped, comprising two planar sheets connected to one another along an adjoining edge. The two planar sheets of a tent-shaped substrate may connect at any angle, for example, at an angle of between 1.0 and 180.0 degrees, all values and ranges therebetween to the first decimal place (tenths). In some embodiments, the two planar sheets connect at an angle of between 20.0 and 45.0 degrees, inclusive and all values and ranges therebetween to the first decimal place (tenths). In various embodiments, the two planar sheets connect at an angle of between 10.0 and 90.0 degrees, between 10.0 and 89.0 degrees, between 10.0 and 60.0 degrees, between 10.0 and 45.0 degrees, between 10.0 and 30.0 degrees, between 10.0 and 20.0 degrees, between 20.0 and 90.0 degrees, between 20.0 and 89.0 degrees, between 20.0 and 60.0 degrees, between 20.0 and 45.0 degrees, between 20.0 and 30.0 degrees, between 30.0 and 90.0 degrees, between 30.0 and 89.0 degrees, between 30.0 and 60.0 degrees, between 30.0 and 45.0 degrees, 45.0 and 90.0 degrees, between 45.0 and 89.0 degrees, between 45.0 and 60.0 degrees, between 60.0 and 90.0 degrees, or between 60.0 and 89.0 degrees. In various embodiments, the two planar sheets connect at an angle of between 90.0 and 179.0 degrees, between 90.0 and 150.0 degrees, between 90.0 and 135.0 degrees, between 90.0 and 120.0 degrees, between 90.0 and 110.0 degrees, between 90.0 and 100.0 degrees, between 100.0 and 179.0 degrees, between 100.0 and 150.0 degrees, between 100.0 and 135.0 degrees, between 100.0 and 120.0 degrees, between 100.0 and 110.0 degrees, between 110.0 and 179.0 degrees, between 110.0 and 150.0 degrees, between 110.0 and 135.0 degrees, between 110.0 and 120.0 degrees, 120.0 and 179.0 degrees, between 120.0 and 150.0 degrees, between 120.0 and 135.0 degrees, between 135.0 and 179.0 degrees, or between 135.0 and 150.0 degrees. In any of the embodiments disclosed herein, the two planar sheets may be connected at an angle so as to form a space between the connected planar sheets and the support. For example, FIG. 26A shows an embodiment where two planar sheets are connected at an angle θ such that a space is formed between the substrates and the support. The space may be at least partially filled. For example, in FIG. 26A, a non-wicking member 560 is disposed between the substrate and the support. Various embodiments may include more than one support, additional planar members, or other materials disposed within the space formed between the planar sheets and the support. In various embodiments, another material disposed between the planar sheets and the support such that the entire space (or substantially the entire space) is filled by the material. For example, a non-wicking filler may be disposed in the space between the planar sheets and the support.

The substrate may be a porous material, such as, for example, a fabric. The substrate may comprise paper and/or plastic, for example, a porous fabric material comprising paper and/or plastic. In some embodiments, the substrate is a hydroentangled, non-woven 55% cellulose/45% polyester blend, such as TechniCloth™ Wiper TX609, available from Texwipe. The word “paper” does not signify, expressly or implicitly, any equivalence between the “paper” used in some embodiments of the subject disclosure and alternative paper material including any prior substrate which may have been called “paper,” but which may have a different or unknown composition or arrangement of fibers. The material may comprise material or material(s) suitable for the purposes of the present substrate as will be apparent in light of the present disclosure.

In some embodiments, the substrate comprises a cellulose/polyester blend. The blend may comprise about 35% to about 75% cellulose, including all integers and ranges therebetween, and about 25% to about 65% polyester, including all integers and ranges therebetween. In an embodiment, the blend may comprise about 55% cellulose and about 45% polyester. In another embodiment, the substrate may consist essentially of cellulose, while in a different embodiments, the substrate does not consist essentially of cellulose.

In some embodiments, the substrate is made from non-woven fibers. In other embodiments, the substrate is made from woven fibers (e.g., yarns). In other embodiments, the substrate is a composite material. For example, the substrate may be made from one or more non-woven layers and/or one or more woven layers. In another example of a composite, the substrate may be made from more than one layer, each layer made from the same or different materials. Plastic or paper filter (virgin kraft paper) may also be used as the substrate. In a further embodiment, the substrate does not consist essentially of any one of the following: coral fleece fabric, cotton, wool, nylon, jute cloth, coir mate or polystyrene sponge.

In some embodiments, the substrate has a dark hue au naturale. In some embodiments, the substrate is coated, dyed, or otherwise colored to attain a dark hue. In some embodiments, the substrate is black or substantially black. For example, the substrate may be coated, dyed, or otherwise colored with carbon black. In some embodiments, the carbon black comprises nanoporous carbon black, microporous carbon black, or a mixture thereof. In another embodiment, the carbon black consists essentially of nanoporous carbon black. Selecting carbon black of a particular sized porosity may be helpful in cleaning contaminated water. However, it is not necessary for the distillation of water, in which general purpose black carbon may be used. Other black or dark pigments may also be used to dye or coat the substrate.

In some embodiments, the substrate may have a length of about 8 cm to about 14 cm and all integers and ranges therebetween. The length was determined by the water transportation capability of the substrate. The exemplary length of about 10 cm to about 14 cm was used in an exemplary embodiment for a hydroentangled (non-woven) substrate comprising about 55% cellulose and about 45% polyester. The width may be greater for more substrates with greater liquid transport potential. The length may be less than 10 cm or greater than 14 cm according to the application at hand.

In some embodiments, the substrate may have a width of about 8 cm to about 14 cm and all integers and ranges therebetween. The width was determined by the water transportation capability of the substrate. The exemplary width of about 8 cm to about 14 cm was used with a hydroentangled (non-woven) substrate comprising about 55% cellulose and about 45% polyester. The width may be greater for more substrates with greater liquid transport potential. The width may be less than 8 cm or greater than 14 cm according to the application at hand.

In some embodiments, the substrate has the shape of a cross. In some embodiments, the substrate has the shape of a square or rectangle. The substrate may be any shape suitable to the application.

In some embodiments, the substrate is corrugated, in whole or in part (see, e.g., FIG. 30). For the corrugation, smaller angles with straight and sharp angle tips may be advantageous. Considering the moving sun light, using corrugation having a smaller depth may be better because using a large depth may cause a shadow effect whereby some substrate will be shielded from light. An upper limit of the corrugation depth may be selected such that the solution can be transported to the entire surface of the substrate. Corrugation not only significantly increases the surface area, but also maintains the evaporated vapor at a relatively low temperature so that energy loss to heat the water and vapor can be suppressed, without being bound by any theory.

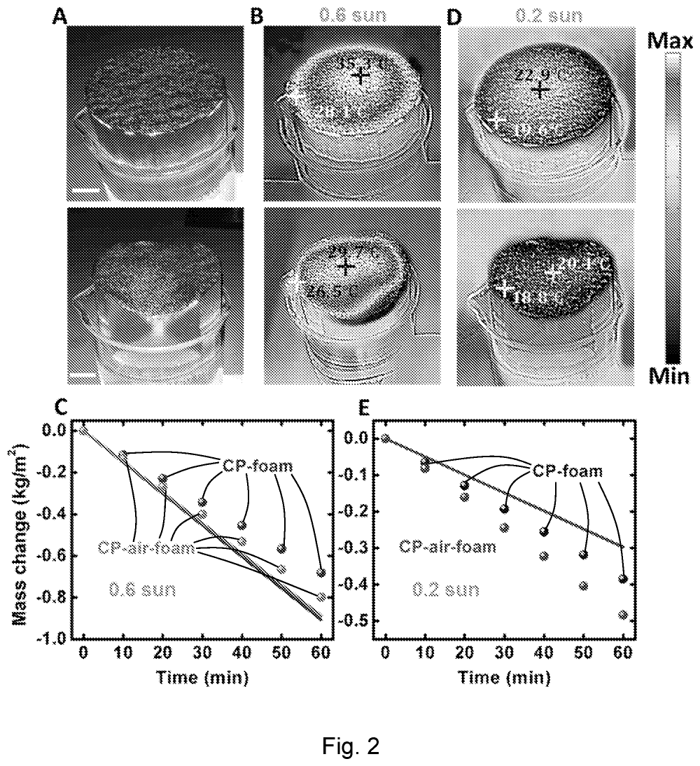

In some embodiments, the substrate and its support float at the surface of the solution. For example, the solution may be source water to be distilled. In such embodiments, where the substrate and its support float on the source water, the dimensions of the support and of the substrate may be selected so that the ends of the substrate overlap the edges of the support and contact the source water as shown in FIG. 2A.

In some embodiments, the support has a length of about 8 to about 10 cm. In some embodiments, the support has a width of about 8 to about 10 cm. The support has a height of about 8 to about 14 cm. The height can be greater for more absorbent substrates or substrates with enhanced liquid transport (wicking) capability. As before, these dimensions were optimized for a hydroentangled (non-woven) substrate comprising about 55% cellulose and about 45% polyester. The dimensions of the support and of the substrate may be selected so that the ends of the substrate overlap the edges of the support as shown in FIG. 2A. Other support sizes may be used and the above are merely exemplary dimensions used to illustrate the present disclosure.

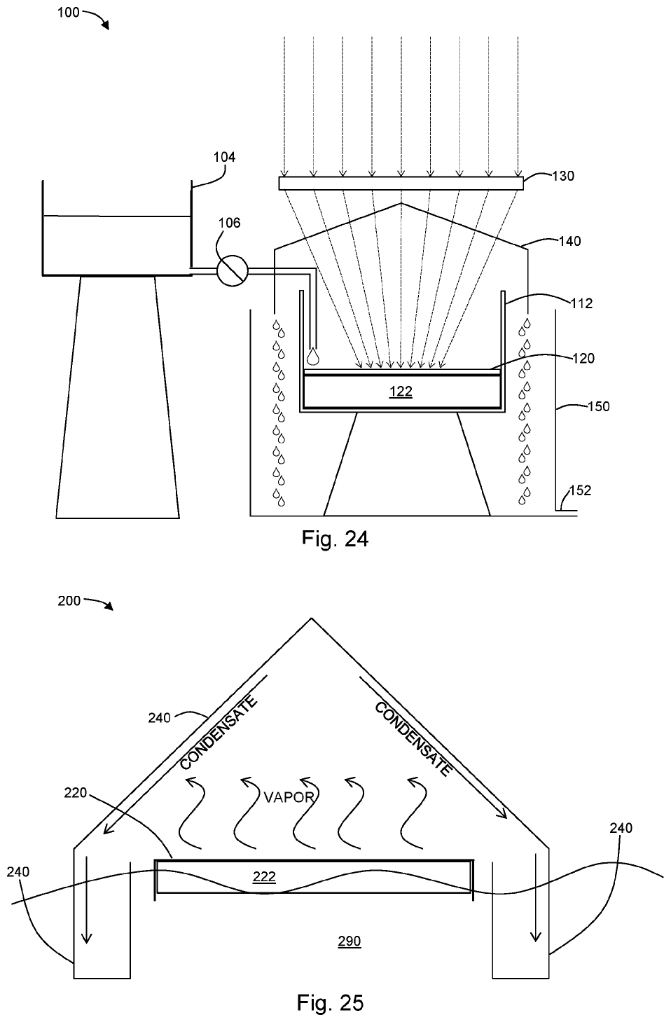

FIG. 24 depicts a solar vapor evaporation and condensation system 100 according to another embodiment of the present disclosure. A water source 104 is configured to provide a supply of water to an open-topped vessel 112. For example, the water source 104 may be higher than the vessel 112 such that water flows by gravity. In some embodiments, the water source 104 may be a dark in color—for example, black—so that the contained water may be heated via solar heating. The system 100 may include a valve 106 configured to regulate the flow of water from the water source 104. The valve 106 may be any suitable type of valve, such as a manually-controlled valve. In some embodiments, the valve 106 may be controlled automatically, for example, based on a water level in the vessel 112. The vessel 112 may be thermally isolative. For example, the vessel 112 may have a double-walled construction. Other thermally isolative configurations will be apparent to the skilled person in light of the present disclosure.

A support 122 is disposed within the vessel 112, and a substrate 120 is disposed on the support 122. As described above, the support 122 may be made from any suitable material, such as, for example, EPS foam. Also as described above, the substrate 120 may be made from a suitable wicking material, such as, for example, CCP. Other materials may be used for the support 122 and/or the substrate 120. The some embodiments, the support 122 is configured to float on water contained within the vessel 112. The substrate 120 may be configured to wick water contained within the vessel 112. The system 100 may include a solar concentrator 130—such as, for example, a Fresnel lens—for increasing the solar energy directed towards the substrate 120.

The system 100 further includes a housing 140, which may be in the shape of a cone, a dome, a pyramid, or any other shape suitable to the purpose as is described herein. The housing 140 is arranged to contain the vessel 112 within. In this way, water vapor evaporating from the water in the vessel 112 will condense on an inner surface of the housing 140 and run down the inner surface for collection in a collection container 150. The collection container 150 may be constructed so as to encourage condensation. For example, the collection container 150 may be constructed using a single-layer of material, such as a plastic or metal material. The system 100 may further include an outlet 152 whereby condensate (distillate) may be accessed for further use/storage.

In another embodiment, a system 200 is configured to be used in a body of water 290 (see, e.g., FIG. 25). For example, the system 200 may be designed to float in a body of water 290, such as, for example, a lake, pond, river, man-made pools, etc. A substrate 220 is disposed on a support 222, and configured to wick water from the body of water 290 (e.g., the substrate 220 may overlap the support 222 and contact the water). The substrate 220 and support 222 may be CCP-EPS foam, or other suitable materials as further described in this disclosure. A housing 240 is configured to contain the substrate 220 and support 222. The housing 240 is arranged such that water vapor evaporated from the substrate 220 is contained within the housing 240 and caused to condense on an inner surface of the housing 240. The housing 240 includes a collection channel 242 arranged to collect condensate which forms on the inner surface of the housing 240. In this way, the condensate will run down the inner surface of the housing 240 into the collection channel 242 where it is collected for use/storage. In some embodiments, the collection channel 242 or a portion thereof is advantageously arranged to be disposed within the bulk water 290 such that the bulk water cools the collection channel 242.

FIG. 26A depicts an example of another embodiment of a solar vapor generation system 500 having a substrate 520 configured in a “tapered” structure. A support 530 is configured to support the substrate 520 above the solution. The substrate 520 is made up of a first planar sheet 522 connected to a second planar sheet 526. A first end 523 of the first planar sheet 522 is connected to a first end 527 of the second planar sheet 526 at an angle θ. For example, the angle may be between 1.0 and 179.0 degrees or any of the ranges stated above (and re-stated below). In the embodiment depicted in FIG. 26A, each of the first planar sheet and the second planar sheet is in contact (i.e., direct contact) with the solution. For example, the embodiment of FIG. 26A shows where each of a second end 524 of the first planar sheet 522 and a second end 528 of the second planar sheet 526 are in contact with the solution 590 by passing through the support 530. FIG. 26B is a detail view showing an alternative embodiment where the second end 524a of the first planar sheet 522a is in direct contact with the solution 590 over a side of the support 530. Both of the embodiments (FIG. 26A and FIG. 26B) depict embodiments in which the planar sheet 522, 522a is in contact (i.e., direct contact) with the solution. In some embodiments, a non-wicking support (non-wicking member 560) may be provided to stabilize the tapered structure. Some embodiments may include a vessel 512 to contain the solution 590.

In the various embodiments described throughout this disclosure, the two planar sheets may be connected to one another along an adjoining edge. For example, the two planar sheets may be parts of the same substrate material which is angled (i.e., bent, folded, etc.) at their respective adjoining edges. The two planar sheets of a substrate of any of the various embodiments herein may connect at any angle, for example, at an angle of between 1.0 and 180.0 degrees, all values and ranges therebetween to the first decimal place (tenths). For example, the two planar sheets may connect at an angle of between 20.0 and 45.0 degrees, inclusive and all values and ranges therebetween to the first decimal place (tenths). In various embodiments, the two planar sheets may connect at an angle of between 10.0 and 90.0 degrees, between 10.0 and 89.0 degrees, between 10.0 and 60.0 degrees, between 10.0 and 45.0 degrees, between 10.0 and 30.0 degrees, between 10.0 and 20.0 degrees, between 20.0 and 90.0 degrees, between 20.0 and 89.0 degrees, between 20.0 and 60.0 degrees, between 20.0 and 45.0 degrees, between 20.0 and 30.0 degrees, between 30.0 and 90.0 degrees, between 30.0 and 89.0 degrees, between 30.0 and 60.0 degrees, between 30.0 and 45.0 degrees, 45.0 and 90.0 degrees, between 45.0 and 89.0 degrees, between 45.0 and 60.0 degrees, between 60.0 and 90.0 degrees, or between 60.0 and 89.0 degrees, inclusive in each case. The two planar sheets may connect at an acute angle (i.e., an angle of less than 90.0 degrees). The two planar sheets may connect at an obtuse angle (i.e., an angle greater than 90.0 degrees). In various embodiments, the two planar sheets may connect at an angle of between 90.0 and 179.0 degrees, between 90.0 and 150.0 degrees, between 90.0 and 135.0 degrees, between 90.0 and 120.0 degrees, between 90.0 and 110.0 degrees, between 90.0 and 100.0 degrees, between 100.0 and 179.0 degrees, between 100.0 and 150.0 degrees, between 100.0 and 135.0 degrees, between 100.0 and 120.0 degrees, between 100.0 and 110.0 degrees, between 110.0 and 179.0 degrees, between 110.0 and 150.0 degrees, between 110.0 and 135.0 degrees, between 110.0 and 120.0 degrees, 120.0 and 179.0 degrees, between 120.0 and 150.0 degrees, between 120.0 and 135.0 degrees, between 135.0 and 179.0 degrees, or between 135.0 and 150.0 degrees, inclusive in each case. In another embodiment, the two planar sheets may be parallel to one another and separated by a non-wicking member except at the adjoining edge of the two planar sheets. Such an assembly (two planar sheets separated by a non-wicking member) may be perpendicular to the support or may be at an angle with respect to the support (e.g., 10.0 degrees, 20.0 degrees, 30.0 degrees, 40.0 degrees, 45.0 degrees, 50.0 degrees, 60.0 degrees, 70.0 degrees, or 80.0 degrees to the support).

FIG. 27 depicts an example of another embodiment of a solar vapor generation system 600 having a substrate 620 configured in an asymmetric “tapered” structure—i.e., where only one of the planar sheets (i.e., “sides” or “wings”) of the tapered structure is in direct contact with the solution 690. In other words, at least one of the planar sheets configured to not directly contact the solution. A support 630 is configured to support the substrate 620 above the solution. The substrate 620 is made up of a first planar sheet 622 connected to a second planar sheet 626. A first end 623 of the first planar sheet 622 is connected to a first end 627 of the second planar sheet 626 at an angle θ. For example, the angle may be between 1.0 and 179.0 degrees or any of the ranges disclosed herein. The embodiment of FIG. 27 shows where a second end 624 of the first planar sheet 622 is in contact with the solution 690 by passing through the support 630, while the second end of the second planar sheet is not in contact with the solution (not in direct contact, but solution will be transported to the second planar sheet via movement through the first planar sheet). In some embodiments, a non-wicking support 660 may be provided to stabilize the tapered structure. Some embodiments may include a vessel 612 to contain the solution 690.

FIG. 28 depicts an example of another embodiment of a solar vapor generation system 700 having a substrate 720 configured in an “umbrella”-shaped structure—i.e., where a central of the planar sheet of the umbrella structure is in direct contact with the solution 790, and neither of two sides (“wings”) of the umbrella structure is in direct contact with the solution 790 (the two sides are configured to not directly contact the solution). A support 730 is configured to support the substrate 720 above the solution. The substrate 720 is made up of a first planar sheet 722 connected to a second planar sheet 726. A first end 723 of the first planar sheet 722 is connected to a first end 727 of the second planar sheet 726 at an angle θ₁. For example, the angle θ₁ may be between 1.0 and 89.0 degrees. The first planar sheet 722 is also connected to a third planar sheet 770. A first end 723 of the first planar sheet 722 is connected to a first end 771 of the third planar sheet 770 at an angle θ₂. For example, the angle θ₂ may be between 1.0 and 89.0 degrees. In some embodiments, the sum of angles θ₁ and θ₁ is within any of the ranges for angle θ disclosed herein. The embodiment of FIG. 28 shows where a second end 724 of the first planar sheet 722 is in contact with the solution 790 by passing through the support 730, while the second end of the second planar sheet and the second end of the third planar sheet are not in contact with the solution (not in direct contact, but solution will be transported to the second and third planar sheets via movement through the first planar sheet). Some embodiments may include a vessel 712 to contain the solution 790.

In various embodiments, the support is configured to support the substrate above the solution. By above the solution or surface of the solution, it is intended that a portion of the substrate is supported above the solution. In other words, a portion of the substrate intended to contact the solution may not be supported above the solution, and the support is still considered to support the substrate above the solution. By contacting the solution, it is intended that the portion of the substrate in contact is at least in contact with a surface of the solution or is partially disposed into the solution. More generally, the substrate is in contact (direct contact) with the solution such that the substrate is able to wick the solution.

In some embodiments, the support includes an air gap 323 between a portion of the substrate 320 and a portion of the support 322 (see, e.g., FIG. 30). Such an air gap may serve as a thermal isolator to minimize thermal dissipation into the bulk water.

In some embodiments, the substrate is impregnated with carbon nanoparticles, for example, to enhance capillary action. As further discussed below, the density of carbon nanoparticles may be, for example, between 0.01 and 0.1 g per cubic centimeter of substrate. In some embodiments, the density of carbon nanoparticles is between 0.05 and 0.8 g per cubic centimeter of substrate.

In some embodiments, the substrate comprises a porous material. In some embodiments, the substrate comprises a fabric, such as, for example, a woven fabric or a non-woven fabric. In some embodiments, the substrate is a cellulose/polyester blend. Such a blend may comprise, for example, 35% to 75% cellulose and 45% to 65% polyester. In other embodiments, such a blend may comprise about 55% cellulose and about 45% polyester. In some embodiments, the substrate comprises cellulose. In some embodiments, the substrate consists essentially of cellulose.

In some embodiments, the substrate, or portions of the substrate, may be made up of more than one layer of material (for example, two or more layers, three or more layers, four or more layers, five or more layers, ten or more layers—or other numbers of layers therebetween or greater than these). For example, the substrate may be made up of two or more layers of the same material. In another example, the substrate is made up of layers, one or more of which may be made from a material which is different from the material of other layers. For example, the substrate may be made from one or more layers of a blend of cellulose and polyester, and an outer layer of the fabric may be a structural fabric. In a particular example, the substrate may include a first planar sheet and a second planar sheet, each of which are made from 12 layers of the same material or one or more different materials.

In another aspect, the present disclosure may be embodied as a method 400 for solar vapor generation including placing a solution, such as a water-based solution in an open-topped vessel (see, e.g., FIG. 31). A substrate may be disposed 403 in and/or on the solution. The substrate may be configured in any way described herein. The substrate may be disposed 403 on the solution using a support, such as a foam support, to float the substrate above a surface of the solution (for example, at or near a top surface of the solution). The substrate is exposed 406 to solar energy thereby causing evaporation of the solvent (e.g., water), or increasing the rate of evaporation of the solvent over the rate at which evaporation would occur without a substrate and/or exposure to solar energy. The method 400 includes maintaining 409 the substrate at a temperature which is below the ambient temperature. The method may include moving air adjacent to the substrate to further increase the rate of evaporation and/or cool the substrate.

Some embodiments include chemically treating the substrate and/or the carbon to be more hydrophilic. In some embodiments, the substrate and/or the carbon is treated with sodium alginate.

As previously mentioned, in some embodiments, the subject invention provides methods and systems for solar distillation of water comprising a substrate on a support. The substrate may be referred to herein as a wick.

The sides, base, distillate channel, and collection container may each independently comprise metal, plastic or wood. The plastic may be acrylic. For the base, plastic or metal are preferred.

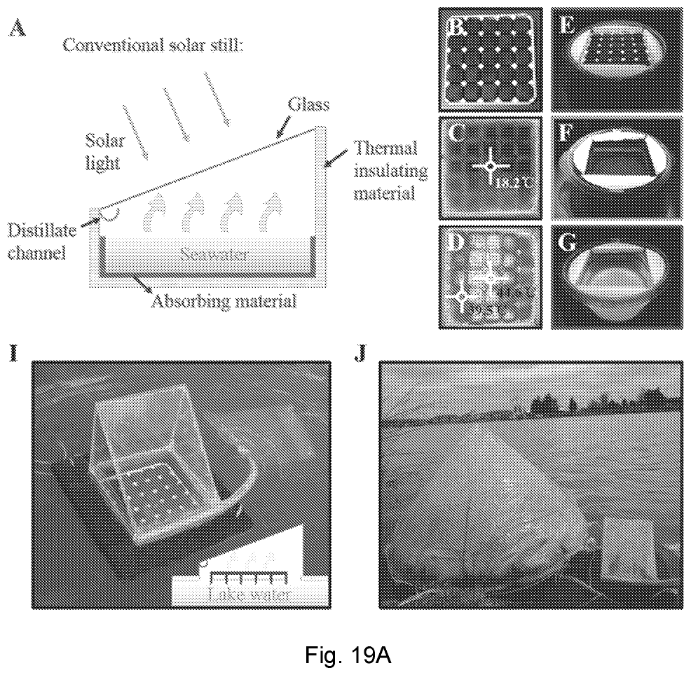

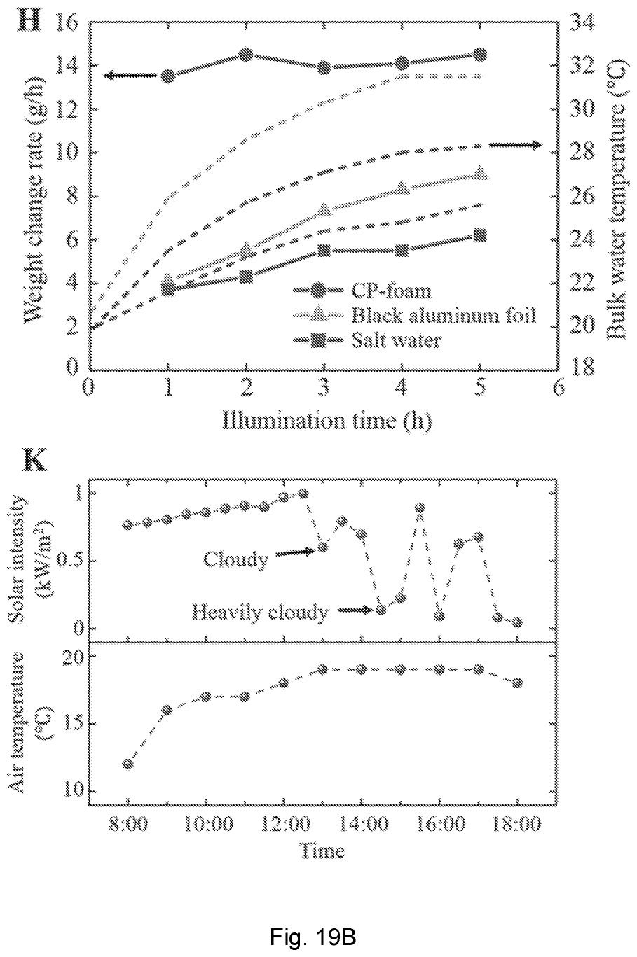

Optionally, foam or other material less dense than water may be added to ensure that the system floats (see, e.g., FIG. 19A(I)). For example, a foam ring or open square may be attached to the lower sides of the system.

In an alternative embodiment, at least an interior surface of the base may angled so that the substrate and its support are angled to face the sun.

Some embodiments of the presently-disclosed techniques are particularly advantageous for use in mining applications, and more particularly, in salt mining applications. Solar salt mining is a common practice to obtain a plethora of different salts ranging from table salt, NaCl, to Lithium-based salts (e.g., Lithium Carbonate, Lithium Hydroxide, Lithium Chloride, etc.), and Sodium/Potassium/Iodine salts for battery, food, and medical applications. While salt processing plants have the ability to process large amounts of raw salt product every year, these plants rarely run at full capacity due to bottlenecks in the production of raw salts from solar evaporation of salt brine. Using embodiments of the present disclosure, the solar evaporation of salt brines can be increased by 3-5× times the natural rate. A low cost carbon nanomaterial based substrate was developed and shown to be >88% efficient at converting solar light into heat (see below under the heading “CCP Discussion and Experimental Details”). This carbon substrate can easily be applied using a roll-to-roll process for extremely feasible scalability and modular systems, allowing the continued use of the existing infrastructure for solar evaporation ponds while providing greatly improved solutions to enhance salt production. To further maintain current infrastructure, the material used may be mechanically stable, thereby allowing the continued use of current collection vehicles to drive over and scoop up the raw salts. In addition to being low cost and scalable, the present carbon-based substrate is chemically inert as to prevent contamination and preserve purity of salt products.

In another aspect suitable for use in mining applications, the present disclosure may be embodied as an apparatus for improved salt separation in an evaporation pond. The apparatus is similar to the above-described system where the open-topped vessel is a pre-existing evaporation pond. As such, the apparatus includes a substrate configured to wick solution from the evaporation pond. The apparatus may include a support, configured to support the substrate at a position above the surface of the solution. By above the solution or surface of the solution, it is intended that a portion of the substrate is supported above the solution. In other words, a portion of the substrate intended to contact the solution may not be supported above the solution, and the support is still considered to support the substrate above the solution. A temperature of the substrate is maintained below an ambient temperature. The substrate of such an apparatus may be of any type described herein and may be configured as a planar sheet or a tent-shaped configuration as described herein.

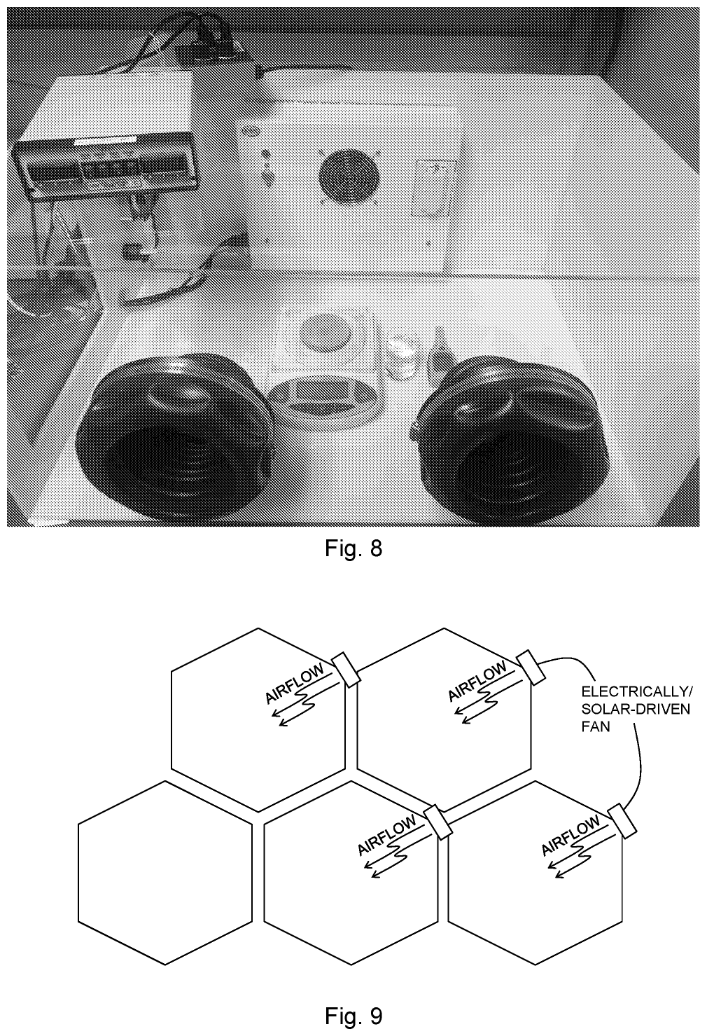

In some embodiments, the substrate is configured in a geometric shape—i.e., having a geometric circumferential shape. In a particular example (illustrated in FIG. 8), the substrate is hexagonally shaped such that a plurality of substrates may be arrayed to cover a large area. Other shapes and array configurations will be apparent in light of the present disclosure and are within the scope of the disclosure.

The substrate may configured for mechanical separation of the salt. For example, the substrate may be a durable material capable of withstanding mechanical separation (scraping, beating, etc.) As such, the substrate may be reusable, such that once the salts have been removed (substantially removed), the substrate may be used to obtain salts again. In some embodiments, the substrate is washable. Here again, such ability to be washed allows for re-use of the substrate.

While solar salt mining focuses on the evaporation of brine water to collect the salts left behind, embodiments of the present system will also enable reclamation of the evaporated water in a condenser unit. In this way, miners and staff may be provided with a fresh supply of drinking water. This means for no additional energy input, other than the natural solar radiation, raw salt production can be enhanced 3-5× while saving time, money, and other resources associated with providing these often remote mining locations with clean drinking water.

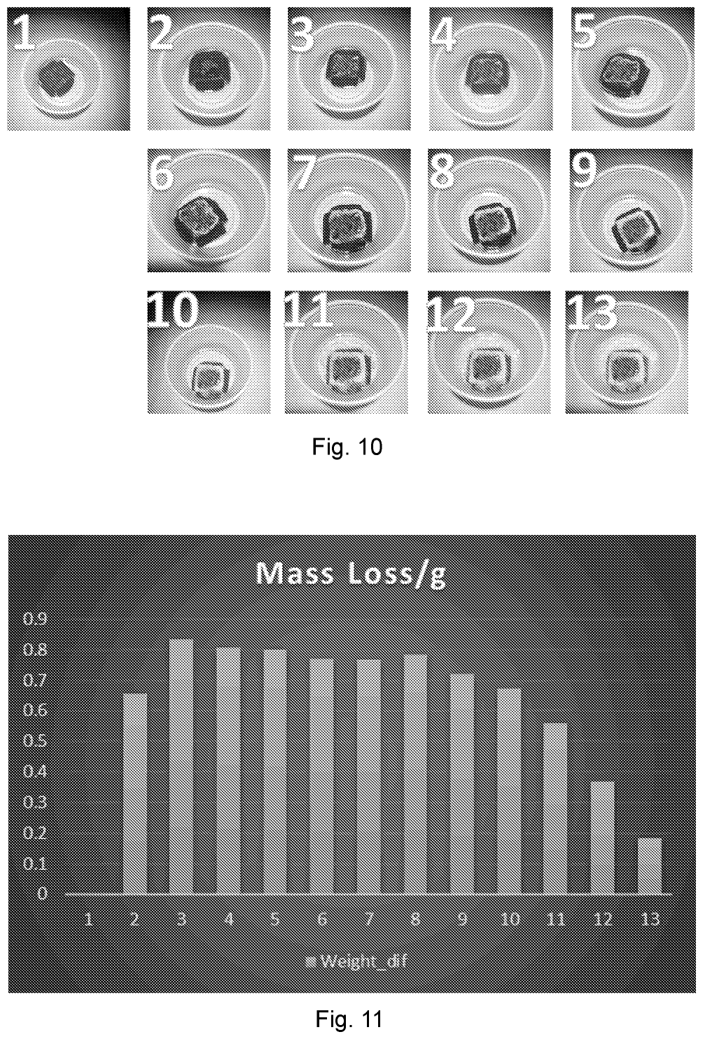

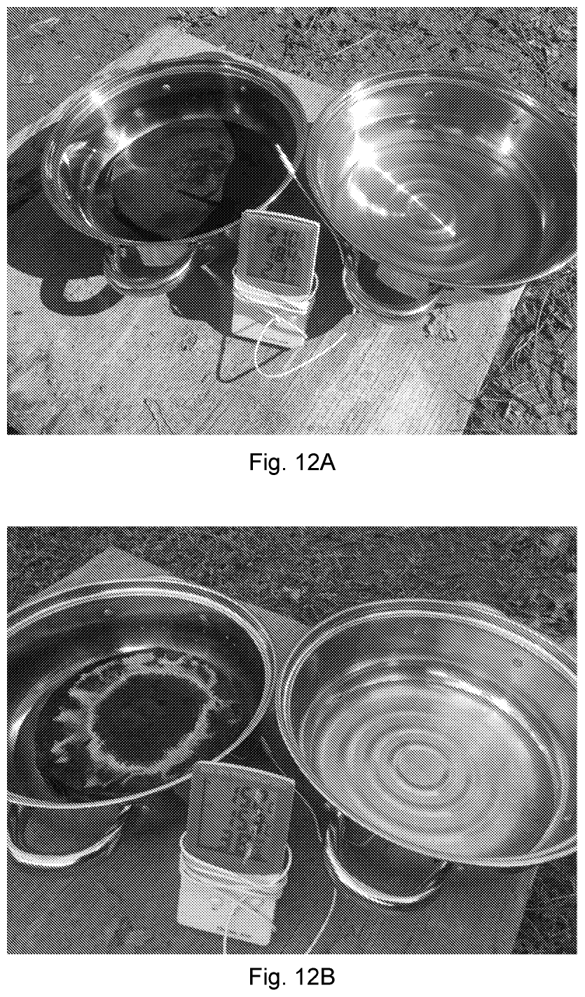

In addition, the CCP structure can also be applied to evaporation enhancement for water having only a low concentration of salt. In such applications, accumulated salt can re-dissolve into the water solution, providing a “self-cleaning” feature and reducing the maintenance required for operation. Additionally, FIG. 10 shows a test embodiment wherein salt tended to accumulate on the surface of the substrate. This tendency may provide an advantage in collecting the accumulated salt. For example, mechanical separation of the salt from the substrate may be easier if the majority of accumulated salt is on a surface of the substrate.

Additionally, the presently-disclosed process includes the geometric assembly of the substrate. Based on geometry, the carbon substrate can be arranged to induce higher airflow speed which increases evaporation rates, prevents adsorption of salts onto the surface of the substrate and easily transfers salts to different collection containers, which aids in overall collection and ease of use/maintenance. As such, the apparatus for salt separation may include one or more air movers (for example, as shown in FIG. 8).

In contrast to water purification applications, solar mining may utilize extra components/devices to accelerate the vapor generation rate. For instance, electricity driven or solar driven fans can be employed in the solar vapor generation for salt mining. According to preliminary experiment results, an air flow from 0.4 to 2 m/s can enhance the vapor generation rate by 1000% (dark environment)˜15% (under 3× sun illumination). In particular, solar driven fans can be included in each solar evaporator model (FIG. 8). In addition, large scale fans can also be installed at the edge of the pond.

### Further Discussion

### Loss Channels in Solar Vapor Generation Systems and the Strategy to Realize the Perfect Efficiency

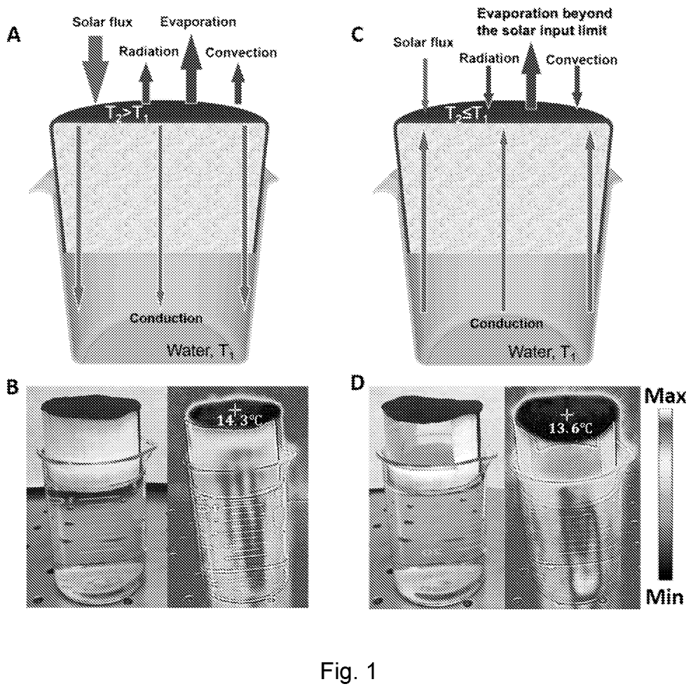

As illustrated in FIG. 1A, major loss channels include net radiation, convection and conduction losses. Therefore, the power flux exchanged with the environment in the solar vapor generation process can be described as:

$$P = α {C}_{opt} {q}_{i} - εσ ( {T}_{2}^{4} - {T}_{1}^{4} ) - h ( {T}_{2} - {T}_{1} ) - {q}_{water} \qquad ( 1 )$$

Here, α is the optical absorption coefficient, Cₒₚₜ is the optical concentration, qᵢ the normal direct solar irradiation (i.e., 1 kW/m² for 1 sun at AM 1.5), ε the optical emission, σ the Stefan-Boltzmann constant (i.e., 5.67×10⁻⁸ W/(m²·K⁴)), T₂ the temperature at the surface of the evaporative material, T₁ the temperature of the adjacent environment, h the convection heat transfer coefficient, and q_{water} the heat flux to the bulk water. This equation describes most major processes (if not all) involved in the evaporation process, i.e., the absorption of light, αCₒₚₜqᵢ, the net radiative loss to the surroundings, εσ(T₂⁴−T₁⁴), the convective loss to the ambient, h(T₂−T₁), and the radiative and conductive loss to the bulk water, q_{water}. By manipulating the energy distribution among these channels, unique solar vapor generation mechanisms can be realized. For instance, a selective absorber and a bubble wrap cover can be introduced to decrease the infrared thermal radiation (ε) and the convective loss (h) to the surroundings, respectively, to produce 100° C. steam under one sun illumination. However, for high temperature solar vapor generation systems, these losses can only be reduced but not eliminated completely. An important question is what happens when T₂≤T₁? In this steady case (with a stable surface temperature), the system will actually take energy from the environment and the absorbed solar energy can only be consumed in the liquid-to-vapor phase transition, corresponding to near perfect solar energy conversion. Next, a thermally isolated CCP on foam was employed as a low-cost test bed to analyze the energy balance and heat transfers under both dark and illuminated conditions.

### Experimental Embodiments and Results

### Materials

In an exemplary embodiment, a substrate of carbon-coated cellulose and polyester blend (CCP) was fabricated using commercially available materials: paper (Texwipe™ TX609) and carbon powder (Sid Richardson Carbon & Energy Company). In some embodiments, evaporation performance can be further manipulated by engineering features of carbon nanomaterials. For example, the light-absorbing substrate can be enhanced with hydrophilic features. In particular, it may be advantageous to provide a substrate that comprises a black material able to absorb water and sunlight simultaneously and evaporate moisture at a higher rate. To improve these characteristics, the porosity of a carbon nanomaterial may be manipulated in some embodiments. In some embodiments, the substrate and/or the carbon may be chemically treated to increase hydrophilicity. In some embodiments, the substrate and/or the carbon may be treated with sodium alginate.

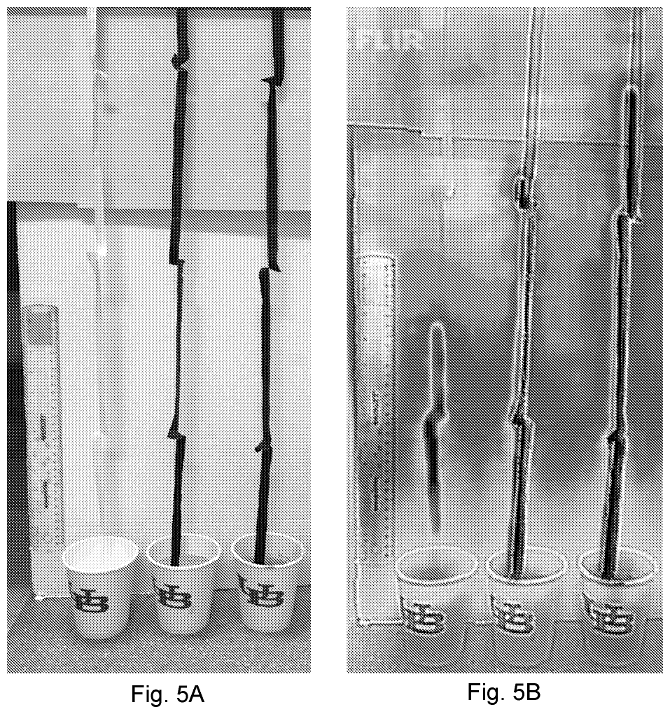

In an experiment to demonstrate such features, water diffusion height was employed as the figure of merit to evaluate the absorptivity of materials under test (FIG. 5A). In the experiment, water diffusion height was measured in substrates made from three sample materials: a first sample comprising a white substrate (left sample); a second sample comprising a substrate coated with a carbon nanomaterial (center sample); and a third sample comprising a carbon-coated substrate similar to the second sample and further treated with sodium alginate (right sample). As shown by the infrared imaging in FIG. 5B, the water diffusion height of the first sample was approximately 23 cm. In the second sample, water diffusion height was approximately 37 cm, demonstrating improved water absorptivity in the CCP material. In the third sample, the hydrophilicity of the sample was improved by the sodium alginate, resulting in a water diffusion height of approximately 43 cm.

### Methods

### Sample Fabrication

2 g carbon powder was dispersed into 400 mL water. 8 mL acetic acid was added to make carbon powder easier to attach to fibers. The solution was mixed in a 1000 ml beaker and blended well using an ultrasonic cleaner (Branson Ultrasonics Bransonic® B200) for 5 minutes. Subsequently, the prepared white substrate was put into the mixed solution to vibrate and stir for 3 minutes so that carbon powders can dye the substrate uniformly. After that, the CCP was dried at 80° C. on a heating stage. This procedure was repeated three to four times to realize a desired dark color.

### Sample Characterization

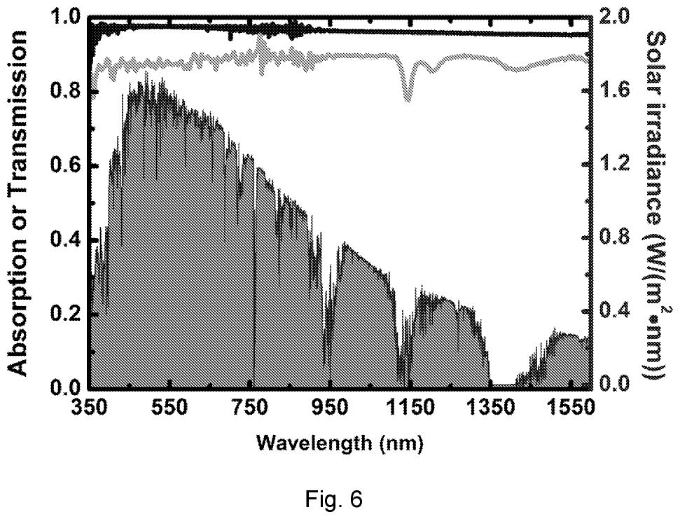

The absorption spectrum using an integration sphere spectroscopy (Thorlabs IS200-4 integrated with Ocean Optics USB2000+, Ocean Optics Jaz, and Avantes AvaSpec-NIR256-1.7TEC for ultraviolet, visible and infrared wavelength range, respectively). By weighting optical absorption spectrum of CCP (the topmost curve in FIG. 6) with the AM 1.5 solar irradiance, the optical absorption was ˜96.9%.

### Solar Vapor Generation

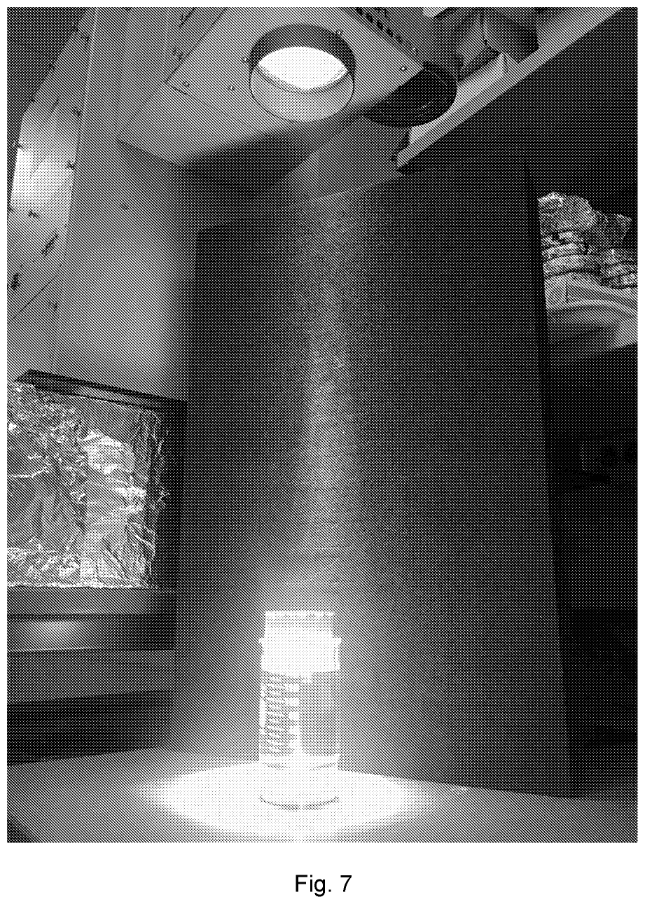

To measure the water evaporation rate, a 150 mL beaker with an inner diameter of 5 cm filled with ˜140 g water was placed under an intensity-tunable solar simulator (Newport 69920), as shown in FIG. 7. Three pieces of diffuser (10 inch×8 inch×0.050 inch polystyrene sheet, Plaskolite) were used to generate a uniform light distribution. As shown by the middle curve in FIG. 6, the overall transmission spectrum was almost wavelength-independent. Therefore the diffuser will not change the spectral feature of the incident light. The solar light intensity was measured using a power meter (PM100D, Thorlabs Inc.) equipped with a thermal sensor (S305C, Thorlabs Inc.) at the same height of the CCP. The CCP was first illuminated for approximately 30 minutes for stabilization. Then the evaporation weight change was measured by an electronic scale (U.S. Solid, with the resolution of 1 mg) every 10 minutes. The surface temperature of CCP was characterized using a portable thermal imager (FLIR ONE®). To calibrate the temperature, a piece of white substrate without illumination was adopted as a reference for room temperature in the same thermal imaging. Its temperature shown in the thermal distribution image was calibrated by a thermometer (GoerTek). In this case, the error in the temperature characterization due to distance from the sample to the thermal imager can be minimized.

### Dark Evaporation

Water evaporation is a natural process which occurs under any conditions regardless of solar illumination. As shown in FIG. 1B, a 19.6 cm² CCP was attached to a foam substrate floating on top of water. Its surface thermal distribution was then characterized using a portable thermal imager (FLIR ONE®). The dark evaporation rate of bare water surface was characterized in a glove box with controlled relative humidity and temperature (ETS Model 5501-11, electro-tech system, Inc., FIG. 8). In this experiment, two sets of measurements were performed by fixing the relative humidity and temperature inside the box, respectively. Each condition was stabilized for 1 hour before the characterization.

One can see that the surface temperature of the CCP is ˜14.3±0.2° C. (T₂), which is lower than that of the room temperature (i.e., T₁=22.3˜23.3° C.). This was characterized in a laboratory environment (with the humidity of 16˜25% in winter time at Buffalo, New York) showing that the average evaporation rate in the dark environment was 0.275 kg/(m²·h). Due to natural evaporation, this process will consume 6.78×10⁵ J/(m²·h) energy from the environment (considering the enthalpy of vaporization at 14.3° C.). Therefore, the energy balance and heat transfer diagram under dark environment (or low intensity illumination condition) is different from that in a previously reported solar heating situation. As shown in FIG. 1C, the heat transfer is actually from the environment to the CCP surface due to the lower temperature of the sample. According to equation (1), the convective input power, P_{con}=−h(T₂−T₁), is approximately 2.88×10⁵ J/(m²·h) (h was assumed to be 10 W/(m²·K)) under dark conditions. This heat transfer direction is valid as long as the CCP surface temperature is lower than the surrounding temperature. In addition, the system has no net radiation loss when T₂≤T₁. Instead, according to the equation P_{rad}=−εσ(T₂⁴−T₁⁴) (ε is 0.969 for the CCP, FIG. 6), the radiative input power can be calculated to be 1.56×10⁵ J/(m²·h). The remaining input is contributed by q_{water} from the substrate dipped in the water and the foam substrate (although it is suppressed significantly). Therefore, the CCP foam system actually takes energy from the environment rather than losing it. From this standpoint, an advantageous material/structure for solar vapor generation should have a higher evaporation rate under dark conditions in oder to achieve a lower equilibrium temperature. As a result of this insight, the foam under the CCP was removed so as to introduce an air gap (CCP-air-foam), the evaporation rate was then enhanced to 0.340 kg/(m²·h), resulting in a lower temperature of ˜13.6° C. at the CCP surface as shown in FIG. 1D. To examine how this arrangement influences solar vapor generation, light illumination was used to accelerate the vapor generation.

### Low Intensity Illumination

In this experiment, a solar simulator (Newport) was employed to illuminate the CCP samples (FIGS. 2A and 7). The light beam was filtered by an optical diffuser (FIG. 6) to get a more uniform beam spot with the power density of ˜0.6 kW/m² (i.e., equivalent to the power of 0.6 Sun at AM 1.5). However, the temperature distribution was not uniform even under uniform solar illumination. One can see that the surface temperature of the central part of the CCP-foam sample (upper panel in FIG. 2B) increased up to 35.3° C., while the CCP-air-foam (lower panel in FIG. 2B) surface temperature increased up to 29.7° C. They are both higher than the room temperature. Therefore, the loss channels highlighted in FIG. 1A will result in lower solar energy conversion efficiency in these areas. One can see from FIG. 2C that these measured average evaporation rates (i.e., 0.68 kg/(m²·h) and 0.80 kg/(m²·h)) are both below the upper limit that can be produced by the input solar energy (i.e., 0.90 kg/(m²·h), the solid curve). It should be noted that the CCP-air-foam sample realized a better vapor generation rate under the same illumination, confirmed by its lower surface temperature.

To minimize these loss channels, the incident power was reduced to ˜0.2 kW/m². As shown by the upper panel in FIG. 2D, the central area temperature of the CCP-foam structure was reduced to 22.9° C. Other areas on this sample are all below room temperature. In addition, the highest temperature of the CCP-air-foam structure was 20.1° C. (lower panel in FIG. 2D), all below room temperature. Under this situation (i.e., FIG. 1C), a total vapor generation rate of 0.39 kg/(m²·h) was obtained for the CCP-foam sample and 0.48 kg/(m²·h) for the CCP-air-foam sample, respectively, as shown by spheres in FIG. 2E. Remarkably, they are all beyond the theoretical upper limit of the vapor generation rate that can be produced by the input solar energy (i.e., ˜0.30 kg/(m²·h), the solid curve in FIG. 2E). It should be noted that the dark evaporation “background” was not subtracted for the reasons discussed below.

### The Background Evaporation

In previously reported solar vapor generation literature, the dark evaporation was usually considered as a background which was subtracted from the total vapor generation to obtain the net solar-induced vapor generation. However, by simply comparing FIGS. 1A and 1C, one can see that the energy balance and heat flow direction under dark conditions were different from those under illuminated conditions. To test this argument, one can simply turn off the solar light and characterize the remaining evaporation rate immediately. Since the surface temperature cannot return to the sub-room-temperature operation immediately, the dark evaporation is not the “background” of the solar vapor generation. Then the question is: What is the “background” ? Or, is there any “background” for solar evaporation?

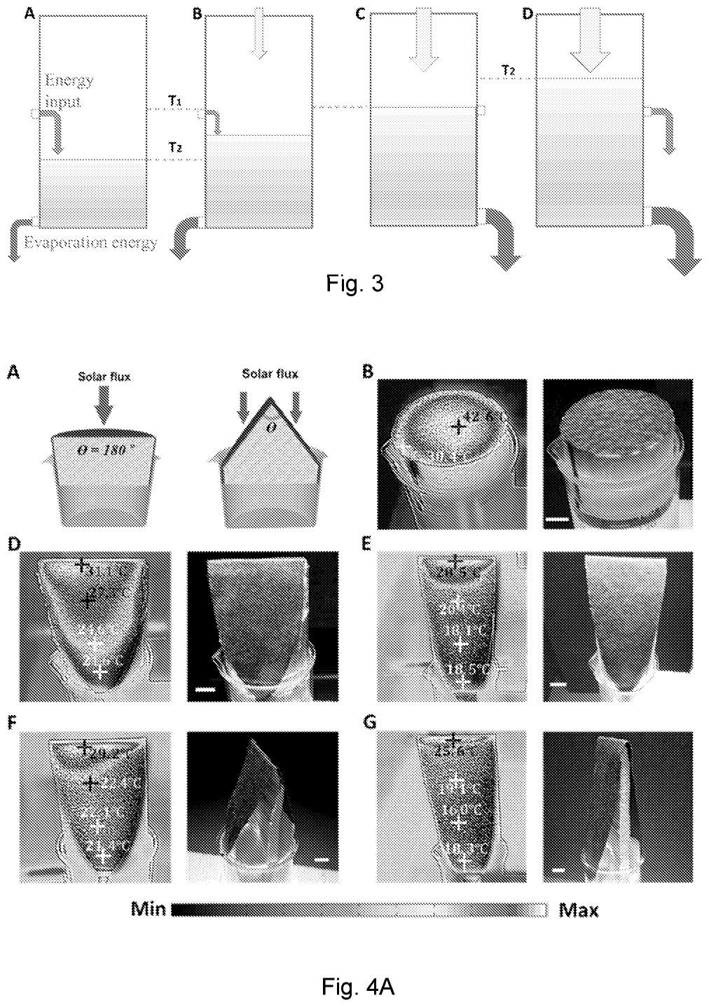

To interpret this intriguing problem, here the energy balance was analyzed using a “water container” model, as illustrated in FIG. 3. Under dark conditions (FIG. 3A), the system took energy from the environment. The energy lost to natural evaporation, Pₒᵤₜ, was in balance with the input energy (Pᵢₙ) from convection, conduction, radiation and others (if any). The system temperature T₂ was lower than the room temperature T₁, and was dependent on the intrinsic evaporation capability of the system under this environment (including temperature, humidity, pressure, system architecture, etc., FIG. 8 and Table 1 below). When a solar energy input was introduced as shown in FIG. 3B, the system temperature increased. During this unsteady process, the system held more energy from the solar input due to its thermal capacity. When the system temperature increased up to the room temperature (FIG. 3C), the input energy channel from the environment closed. Ultimately, the output energy consumed by the evaporation was in balance with the input solar energy with 100% conversion efficiency under the new steady state. When the input solar energy was increased further (FIG. 3D), the system temperature T₂ was higher than T₁. Then the energy was lost through conduction, convection and radiation channels. In this case, the evaporation energy was always smaller than the input energy. Therefore, the absorbed solar energy conversion efficiency was definitely smaller than 100% and the obtained vapor generation rate could not surpass the theoretical upper limit. In particular, when the light was turned off, the evaporation rate did not change immediately due to the stored thermal energy in the system. One can see that in this process, no dark “background” should be considered since there was no energy flow from the environment to the system (as illustrated in FIG. 3A). Importantly, this physical picture pointed out a strategy to realize the vapor generation rate beyond the solar upper limit, as will be discussed in the next section.

TABLE 1
Measured dark evaporation rates of a bare
water surface in controlled environment.

| Relative humidity | | Temperature (° C.) | |
|---|---|---|---|
| at the temperature | Rate | at the relative | Rate |
| of ~23.6° C. | (kg/(m² · h)) | humility of ~26% | (kg/(m² · h)) |
| 26% ± 1% | 0.0955 | 23 ± 0.8 | 0.1009 |
| 46% ± 1% | 0.0787 | 27 ± 0.8 | 0.1070 |
| 66% ± 1% | 0.0465 | 31 ± 0.8 | 0.1315 |

### Surpassing the Solar Upper Limit: Reducing the Power Density Using Larger Surface Areas

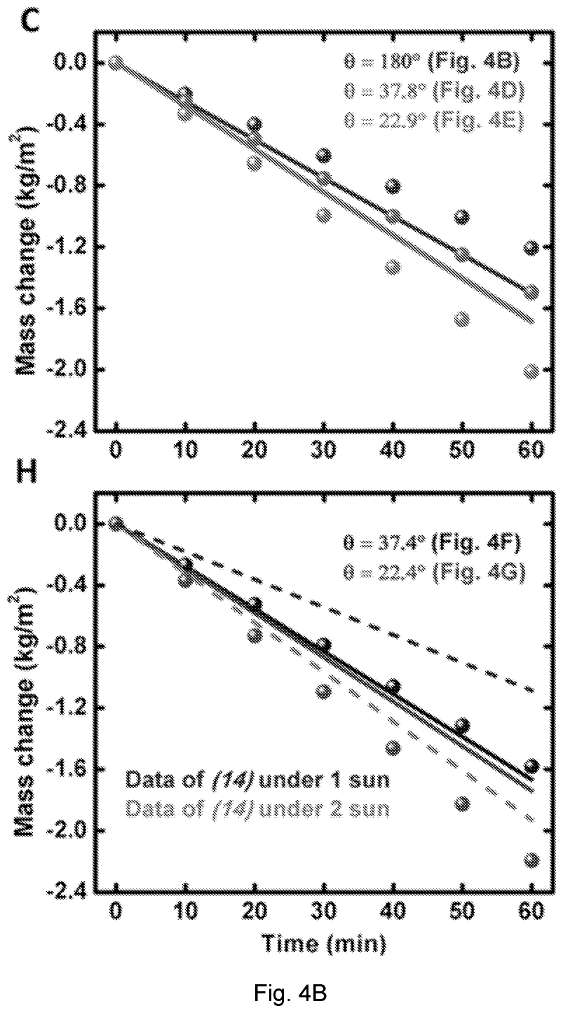

As illustrated in FIG. 3B, below-room-temperature operation allows for obtaining total vapor generation rates that surpass the solar input limit (FIG. 2E). However, due to the weak solar illumination, the total vapor generation rate was still relatively low. A first embodiment for realizing this below-room-temperature strategy under a practical 1 sun illumination is to increase the actual surface area within a given projection area, for example, as illustrated in FIG. 4A(A). To demonstrate this strategy, a set of triangle structures was fabricated with different apex angles (θ) and their surface temperature distributions was compared with a flat sample. As shown in FIG. 4A(B), the highest temperature on the flat CCP sample was 42.6° C. The measured mass change and the theoretical upper limit data were plotted in FIG. 4B(C). Since the surface temperature of the flat CCP sample was higher than the room temperature, corresponding to the lossy system in FIG. 3D, the measured vapor generation rate (˜1.21 kg/(m²·h), see top set of spheres) was lower than that of the theoretical limit (˜1.58 kg/(m²·h), the top curve).

When the same light was employed to illuminate the triangle samples with larger surface areas (FIGS. 4A(D)-4A(E)), the temperature decreased significantly compared with the flat sample shown in FIG. 4A(B). Here four temperature points are indicated at different areas along the side walls. One can see that a major area of the sample in FIG. 4A(D) (θ=390) was still higher than the room temperature. As a result, a total evaporation rate of ˜1.50 kg/(m² h) was observed, which was ˜88.9% of the input solar energy (see middle set of spheres and the bottom curve in FIG. 4B(C)). This efficiency was improved compared with the flat CCP sample in FIG. 4A(B). More intriguingly, for the sample with larger surface areas (θ=230) as shown in FIG. 4A(E), the surface temperature was decreased further with major areas below-room-temperature. In this case, a total vapor generation rate of ˜2.02 kg/(m²·h) was observed (bottom set of spheres in FIG. 4B(C)), which was higher than the theoretical upper limit (˜1.65 kg/(m²·h), see the bottom curve in FIG. 4B(C) and Table 2 below). Ultimately, the foam under these two triangle samples was removed to get CCP-air triangle samples to further enhance the convection contribution from the surroundings and accelerate the evaporation rate. As shown by FIGS. 4A(F)-4A(G), the surface temperatures can be reduced further under the same illumination conditions, indicating the improved vapor generation rates. As shown in FIG. 4B(H), total vapor generation rates of 1.58 kg/(m²·h) were obtained for the sample in FIG. 4A(F) and 2.20 kg/(m²·h) for the sample in FIG. 4A(G), respectively. In particular, the best result of 2.20 kg/(m²·h) was even faster than those reported by other systems under 1-2 sun illumination (e.g., ˜1.09 kg/(m²·h) under 1 sun and ˜1.93 kg/(m²·h) under 2 sun reported by others, see dashed lines in FIG. 4B(H)). This encouraging result indicates the potential to realize ultra-efficient and high performance solar stills based on extremely low cost materials.

TABLE 2
The values of solar intensity and the enthalpy
of evaporation used in the calculation.

| | Solar intensity | Enthalpy of |
|---|---|---|
| | (kW/m²) | evaporation (J/g) |
| Upper panel of FIG. 2B | 0.609 | 2419.5 |
| Lower panel of FIG. 2B | 0.600 | 2435.7 |
| Upper panel of FIG. 2D | 0.203 | 2448.2 |
| Lower panel of FIG. 2D | 0.203 | 2453.6 |
| Left panels of FIG. 4A(B) | 1.001 | 2399.9 |
| Left panels of FIG. 4A(D) | 1.136 | 2433.9 |
| Left panels of FIG. 4A(E) | 1.146 | 2439.1 |
| Left panels of FIG. 4A(F) | 1.127 | 2437.1 |
| Left panels of FIG. 4A(G) | 1.181 | 2444.2 |

### Calculation of the Solar Vapor Generation Rate

In describing the present techniques for limit-breaking solar vapor generation rate beyond the input solar energy limit, the theoretical upper limit was estimated as described below.

In this calculation, the solar energy was assumed to transfer solely to the liquid-vapor transition without any other losses. Therefore, the obtained solar vapor generation rate was equal to the solar intensity (J/(m²·h)) divided by the enthalpy of evaporation (J/kg).

The solar intensity was measured by placing the aforementioned S305C thermal sensor perpendicular to the light beam. For triangle structures shown in FIGS. 4A and 4B, the solar intensity at different height was slightly different due to the diffraction of the beam. In this case, the highest value at the top position was employed to calculate the theoretical upper limit so that the limit-breaking experiment result is unambiguous. For instance, in the left panel of FIG. 4A(G), the strongest illumination at the top of the triangle sample, 1.181 sun as the solar intensity (i.e., 1.181 kW/m²=4.2516×10⁶ J/(m²·h)) was employed.

The enthalpy of evaporation is temperature dependent. Therefore, an analysis was performed of the temperature distribution on the CCP surface, which was non-uniform (FIGS. 2 and 4). The energy flow condition varied on the same CCP sample due to the non-uniform temperature distribution. Since the enthalpy of evaporation is smaller at higher temperature, the enthalpy of evaporation corresponding to the highest temperature on the CCP surface was selected to calculate the theoretical upper limit. For example, in the left panel of FIG. 4A(G), the enthalpy of evaporation of 2444.2 J/g (i.e., 2.4442×10⁶ J/kg) at 25.6° C. was adopted (i.e., the highest temperature on the CCP surface). Under the 1.181 sun solar illumination, the theoretical upper limit of the vapor generation rate was 1.739 kg/(m²·h). Considering the actual optical absorption of ˜96.9%, the theoretical upper limit was 1.685 kg/(m²·h). All values used in the calculation are listed in Table 2 above.

### CCP Discussion and Experimental Details

### CCP for Solar Vapor Generation

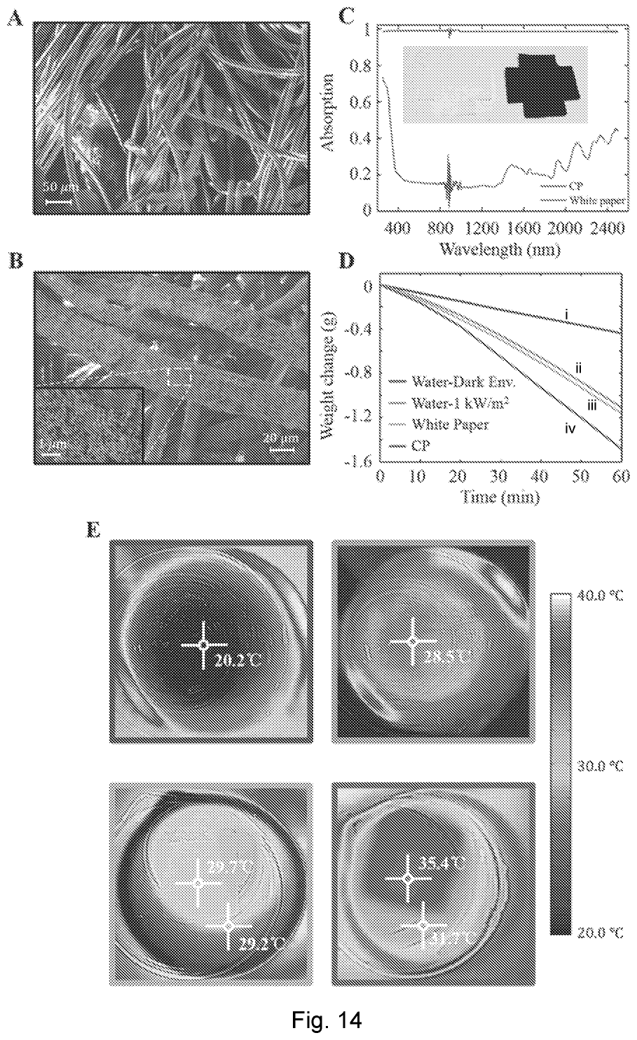

A hydrophilic porous material, a fiber-rich nonwoven 55% cellulose/45% polyester blend (TechniCloth™ Wiper TX609, available from Texwipe™) was selected for use in a test embodiment. This substrate was chosen for its extremely low cost (i.e., retail price of ˜$1.05/m²), chemical-binder-free make up, and has excellent water transport properties. Its microstructure is shown in FIG. 14A, having 10-20-μm-wide fiber bundles. The substrate was dyed using low cost carbon black powders (e.g., SidRichardson Carbon & Energy Co., retail price of $2.26/lb).

Sample preparation: 0.8 g carbon powder (Sid Richardson Carbon & Energy Co.) was dispersed into a 160 mL water. 3 mL acetic acid was added to make carbon powder easier to attach to fibers. The mixed solution was blended well using an ultrasonic cleaner (Branson Ultrasonics Bransonic™ B200) for 5 minutes. Subsequently, the 2 cm×2 cm white paper (TechniCloth™ Wiper TX609, available from Texwipe™) was put into the mixed solution to vibrate for 3 minutes so that carbon powders can dye the paper uniformly. After that, the CCP was dried at 80° C. on a heating stage. This procedure was repeated three to four times to realize a dark shade (see FIG. 14C).

As a result of the dying process, the fibers were coated with carbon nanoparticles, as shown in FIG. 14B. The direct comparison between the white paper and the carbon-coated paper is shown in the inset of FIG. 14C. The optical absorption of the CCP was very strong with the average absorption of ˜98% throughout the visible to near IR domain (from 250 nm to 2.5 μm, measured by a spectrophotometer equipped with an integration sphere, Shimadzu UV-3150). This strong broadband optical absorption is particularly useful for low-cost solar-to-heat conversion.

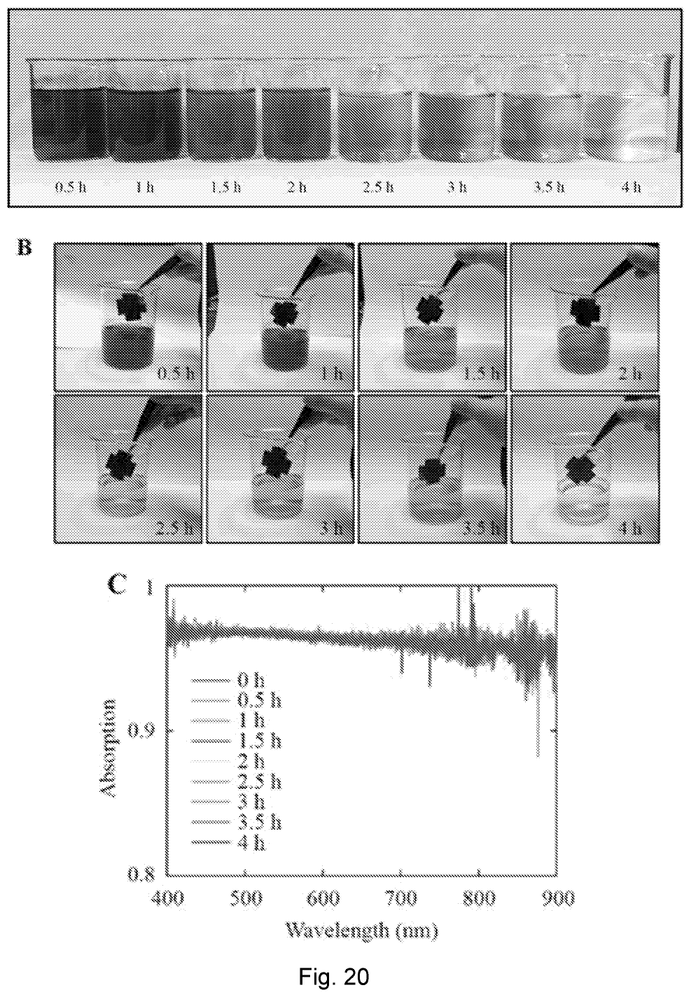

Stability/durability test: To demonstrate the stability/durability of carbon powder attached on the paper fibers, a CCP sample was cleaned ultrasonically in clean water. The water solution was changed every 30 minutes to visualize the effect of the ultrasonic cleaning. As shown in FIG. 20A, the amount of carbon powder washed from the CCP decreased gradually. After 4 hours, no obvious carbon powder was visible in the water. It was noted that there was no apparent change in the shade of the CCP sample (FIG. 20B). To evaluate the cleaning effect of the ultrasonic vibration process, the absorption spectrum was characterized using an integration sphere spectroscopy (Thorlabs IS200-4 integrated with Ocean Optics Jaz) and the optical performance was confirmed as was almost unchanged (FIG. 20C). This test provided strong evidence to demonstrate the great durability of the CCP sample.

To demonstrate the baseline for solar vapor generation performance, a direct comparison was performed under several different conditions as shown in FIG. 14D.

To measure the water evaporation rate, a 250 mL beaker (open area of the beaker was 35.3 cm²) filled with ˜165 g water was placed under a solar simulator (Newport 69920). The CCP floated on the water surface with or without the EPS foam. The residual water surface was covered by EPS foam to eliminate natural evaporation. Two pieces of Fresnel lens (26 cm×17.8 cm, focal length: 300 mm, OpticLens) were used to concentrate solar light. 1-10 times concentrated solar light was calibrated using a powermeter (PM100D, Thorlabs Inc.) equipped with a thermal sensor (S305C, Thorlabs Inc.) The evaporation weight change was measured by an electronic scale every 10 minutes.

In a dark environment (i.e., at room temperature of 21° C. and humidity of 10%), the water weight loss was 0.44 g/h. Therefore, the average evaporation rate in the dark environment was 0.125 kg/(m²·h), which was subtracted from all subsequent measured evaporation rates to eliminate the effect of natural water evaporation. Under solar illumination using a solar simulator (Newport 69920 with the solar intensity of 1 kW/m², i.e., AM1.5), the weight loss increased to 1.11 g/h. After that, a 4×4 cm² white paper and a 4×4 cm² CCP were placed on top of the water surface, and the weight change increased to 1.16 g/h and 1.48 g/h, respectively. To interpret the weight change difference, a portable thermal imager (FLIR ONE®) was used to characterize the temperature of these samples. The thermal imaging characterization was confirmed by a direct measurement using a thermocouple sensor probe, indicating a reasonable accuracy (i.e., ≤0.4° C. in the 33-35° C. range).

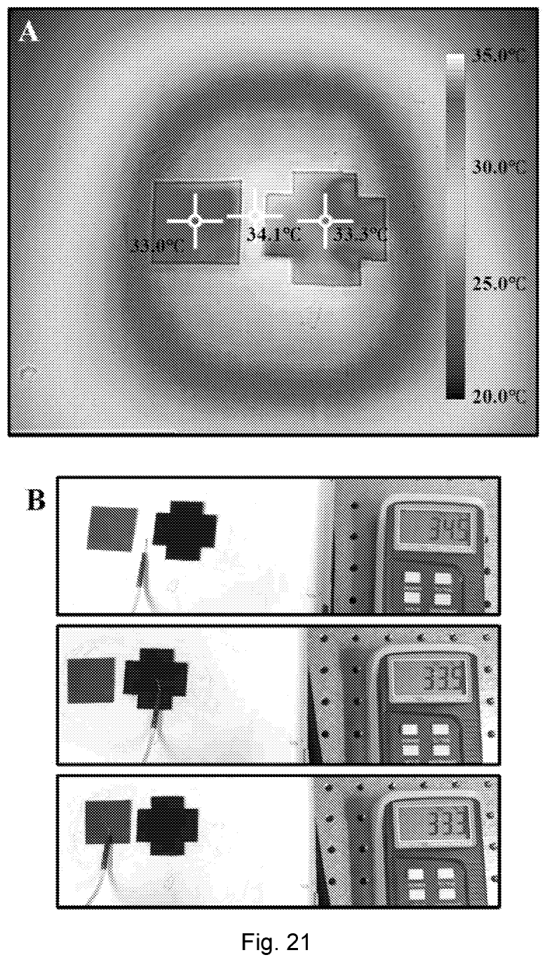

To demonstrate the accuracy of the thermal imaging used in the experiment, two samples (i.e., black Al foil and CCP sample) were placed on a heat plate (Super-Nuova™, HP131725). FIG. 21A shows the thermal image when the temperature of the heat plate was set to 40° C. The temperature was then measured at three different positions using a thermal couple sensor probe (Signstek 6802 II, see FIG. 21B), demonstrating the reasonable accuracy of the thermal imaging (i.e., ≤0.4° C.). Therefore, the temperature change over 5-10° C. observed in the subsequent characterization is reliable based on the thermal imaging data. It is noted that accurate measurement of the surface temperature is a technical challenge since it is dependent on many factors, especially the emissivity of the object being observed and the distance to the object. Therefore, thermal imager estimation of the temperature in the literature is usually not accurate.

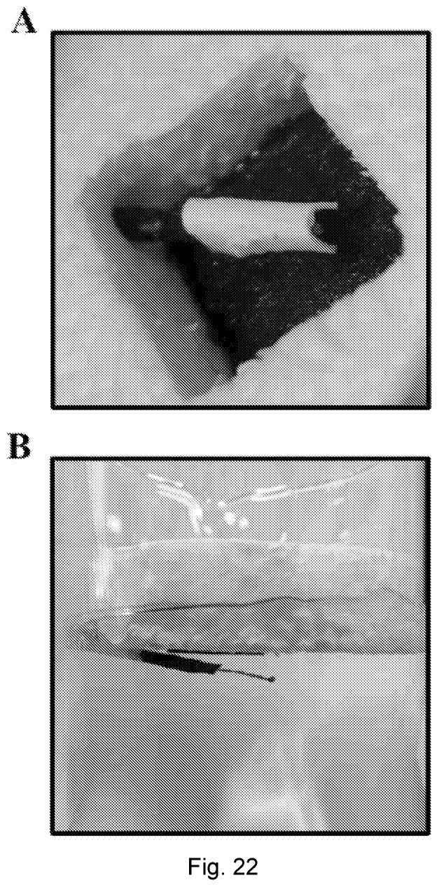

To interpret the evaporation rate difference, the IR thermal imager (FLIR ONE, FLIR system) was used to measure the surface temperature of different samples. The vapor and liquid temperatures were also measured by a thermometer equipped with two K-Type thermocouple sensor probes (Signstek 6802 II). One of the probes was placed above the CCP sample and covered by a small piece of white cardboard to eliminate the heating effect of direct illumination (FIG. 22A). The other one was placed under the CCP sample to measure the temperature of bulk water (FIG. 22B).

As shown in FIG. 14E, the CCP surface temperature increased to the highest degree of 35.4° C. due to the enhanced solar-to-heat conversion.

However, this heating effect was not well isolated from the bulk water (i.e., the bulk water was heated to 31.7° C.), resulting in less efficient vapor generation effect. One can see that the water evaporation speed with the CCP was 1.33 times higher than that of pure water under the 1 kW/m² solar illumination.

### Efficient Vapor Generation Using Thermally Isolated CCP

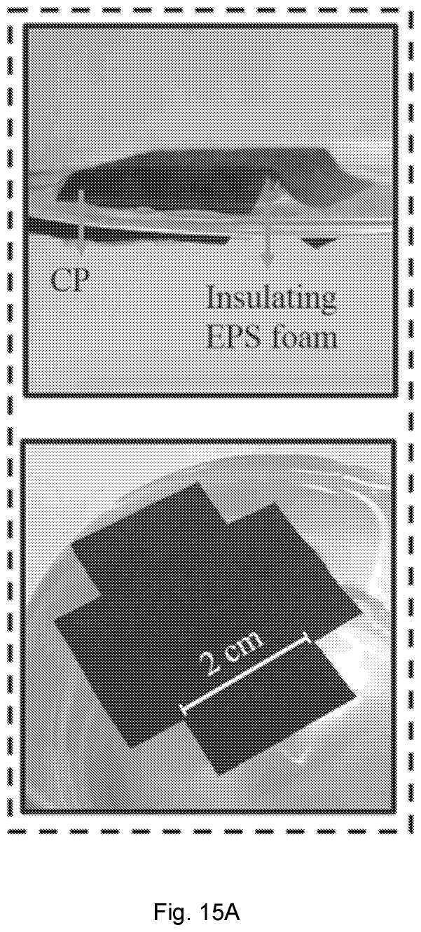

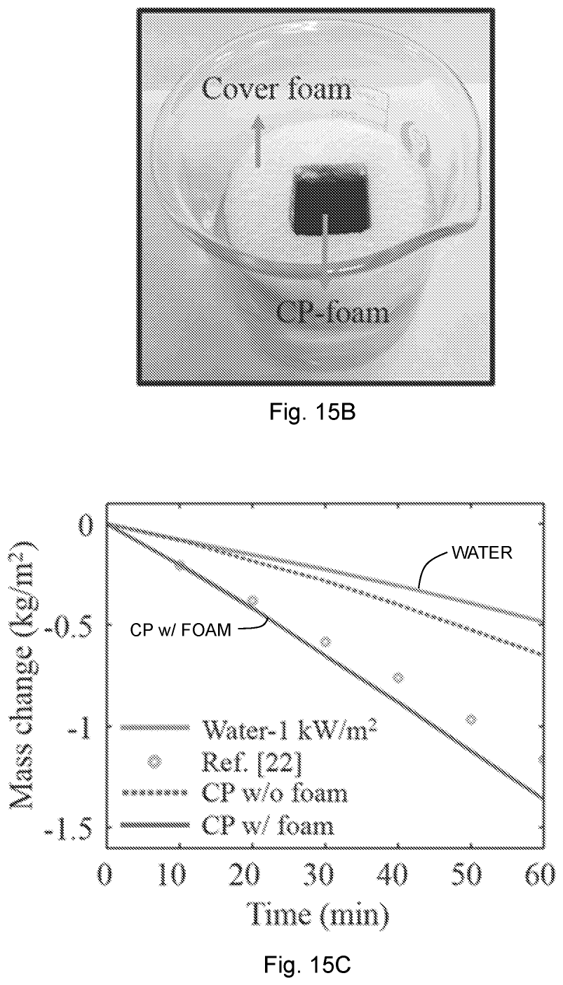

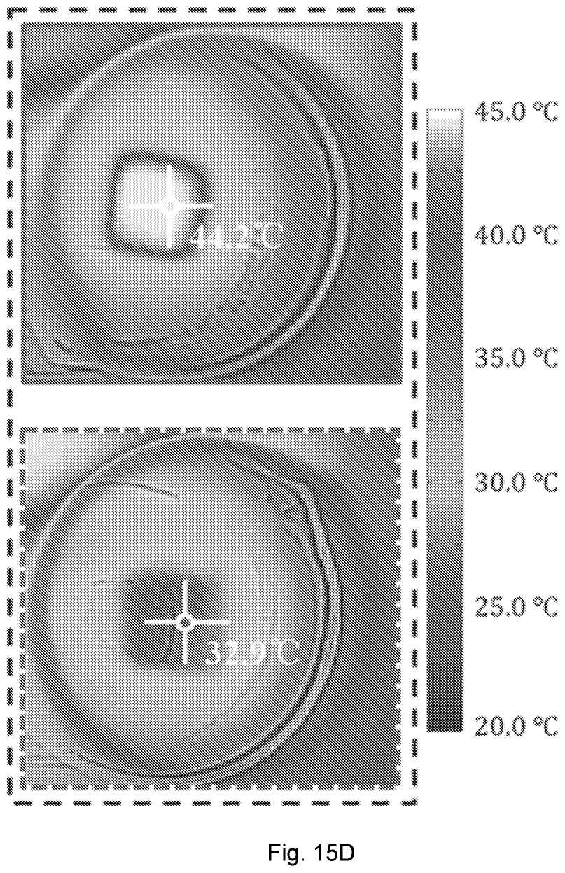

A thermal-isolating strategy was employed to confine the heating effect at the top surface for more efficient vapor generation. The finite thickness, large contact area and fluid transport of previously studied porous substrates led to relatively poor thermal insulation performance (e.g., in two previous studies, the thermal conductivities were 0.49 W/(m·K) and 0.426 W/(m·K)). Without being bound by any theory, a strategy was utilized for the test embodiment to make full use of the capillary force of the porous paper to draw fluid up around the support rather than through it, thus minimizing the thermal loss to the bulk fluid below. As shown by the upper panel in FIG. 15A, a 6-mm-thick EPS foam slab was inserted under the CCP to thermally isolate the porous paper from the bulk water. The thermal conductivity of this EPS foam was 0.034˜0.04 W/(m·K), one of the lowest thermal conductivities available among extremely low cost materials. In this configuration, the only contact area between the water and CCP was at the edges of the porous paper (i.e., a line contact). This significantly reduced the region of fluid transport compared to placing the substrate directly on the water surface (see the lower panel in FIG. 15A). In this case, the paper contacting the water along the sides of the EPS foam transported the water droplets to the upper surface to facilitate evaporation. It should be noted that during testing, the upper surface of the CCP was always wet, indicating that this reduction in transport area did not limit the evaporation rate of the system.

To eliminate water evaporation from other open areas, the surrounding exposed water surface was covered with EPS foam with a square hole for the CCP (FIG. 15B). To demonstrate the thermal isolation effect, the surface temperature was characterized with and without the EPS foam under the CCP, as shown in FIG. 2C. Under solar light illumination having an intensity of 1 kW/m², the upper surface temperature of the CCP increased from 32.9° C. (lower panel) to 44.2° C. with the EPS foam insulation (upper panel). The vapor generation performance is shown in FIG. 15C. One can see that the water mass change improved to 1.28 kg/(m²·h), which was 3.0 times greater than that of the pure water case and 2.0 times greater than that of CCP without EPS foam isolation. This evaporation rate was better than the best reported data under 1 sun illumination with no solar concentration using exfoliated graphite (i.e., circles of FIG. 15C). In principle, one would only need a ˜0.2 m² structure to produce 2 liters of fresh water to meet an individual's daily needs assuming 8-hours of non-concentrated solar illumination. Solar concentration enhances this generation rate further.

### Characterization of the Liquid Transportation Rate of the CCP

A potential concern for reduced liquid flow cross section would decrease the liquid flow rate to the CCP surface. To characterize this practical upper limit, the liquid transportation capability of the CCP was characterized. The original weight of a CCP sample was measured, and then an edge of the sample was placed into water and the IR imager was used to monitor water flow as the function of time. The 4-cm-long sample was saturated by water in ˜25 seconds after which the weight of the wet-CCP was measured. It was noted that the flow rate was not a constant when the paper was saturated. By considering the small cross-sectional area of the CCP-layer (i.e., ˜0.2 mm×2 cm), the practical upper limit of the CCP sample was well over 1,500 kg/m²/h, which is higher than the theoretical upper limit under 1,000× solar concentration. Therefore, the reduced liquid flow rate was not a limitation in the test system under small to moderate solar concentration.

### High Solar Thermal Conversion Efficiency

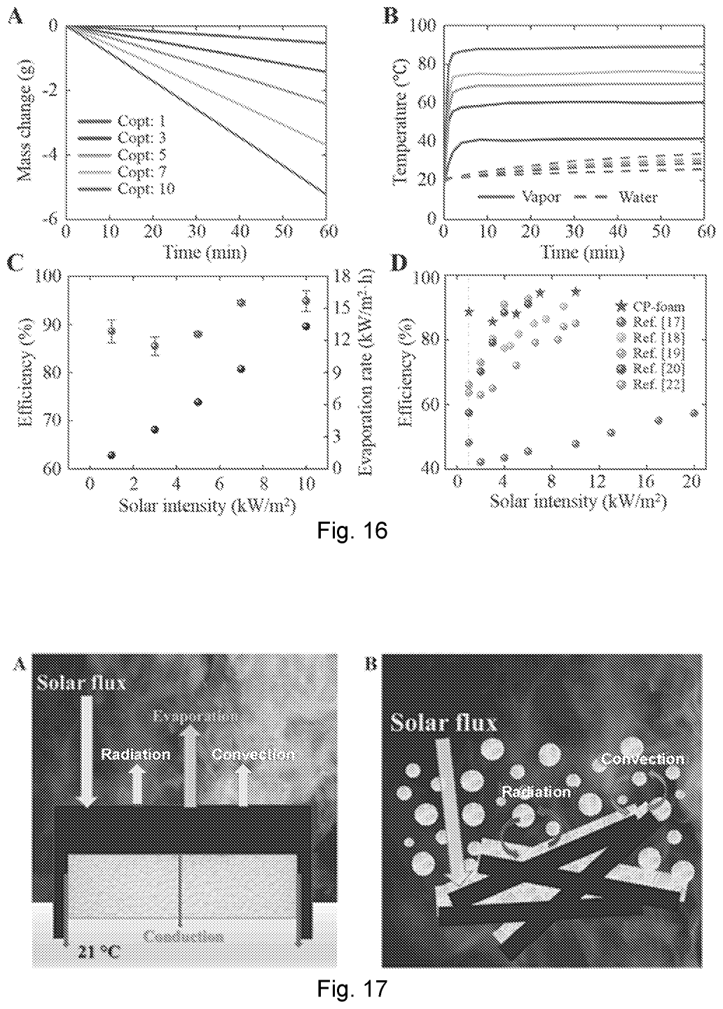

In most previously reported work, the sample surface was always wet, indicating that the performance was limited by surface temperature only. Therefore, the ultimate performance can be improved by introducing concentrated solar illumination. Thus, the vapor generation performance was analyzed under moderate solar concentration conditions to better compare with previously reported nanostructures. In this experiment, an inexpensive planar PVC Fresnel lens (e.g., OpticLens®, $2.39/piece with the area of 26 cm×17.8 cm) was employed to focus the incident light from the solar simulator. As shown in FIG. 16A, when the solar light was concentrated by 3, 5, 7 and 10 times, the water mass change was increased to 3.66, 6.24, 9.34, and 13.30 kg/(m²·h), respectively. To characterize the enhanced surface heating effect more accurately, two thermocouple sensor probes were used to measure the temperature of vapor and bulk water (see FIG. 22). As shown by solid curves in FIG. 16B, the vapor temperature increased sharply within the first 3 minutes and reached a steady state after 10 minutes. In contrast, the temperature of bulk water increased slowly and continuously as shown by dashed lines in FIG. 16B. Higher concentration of light led to higher vapor and bulk water temperatures. Using Equation (2) below, a solar conversion thermal efficiency, ηₜₕ, of 88.6% was obtained under 1 sun illumination, and 94.8% under 10 times solar concentration, as shown in FIG. 16C. Compared with previous reports, this CCP-foam structure realized a very high solar thermal conversion efficiency, especially under low optical concentration condition. However, the test system shows that there is no need to employ large area solar concentrating systems, in contrast to other, more expensive systems.

To evaluate the solar-vapor generation performance quantitatively, the solar conversion thermal efficiency, ηₜₕ, was calculated, using Equation (2):

$${η}_{th} = \frac{\dot{m} {h}_{LV}}{{c}_{opt} {q}_{i}} \qquad ( 2 )$$

where \dot{m} is the mass flux, h_{LV} is the total enthalpy of liquid-vapor phase change, Cₒₚₜ is the optical concentration, and qᵢ is the normal direct solar irradiation (i.e., 1 kW/m²). Particularly, the calculation of the total enthalpy of liquid-vapor phase change, h_{LV}, should consider both the sensible heat and the temperature-dependent enthalpy of vaporization.

The thermal conversion efficiency, ηₜₕ, is widely employed in the literature as an important figure of merit in evaluating the performance of solar vapor generation. However, the detailed values for parameters employed in those literature are slightly different. Therefore, it is necessary to explain the calculation in detail to demonstrate that the presently-obtained ηₜₕ was unambiguously higher than previously reported results.

The most frequently used equation for thermal conversion efficiency is

$${η}_{th} = \frac{\dot{m} {h}_{LV}}{{c}_{opt} {q}_{i}} . \qquad ( Eq . ( 2 ) )$$

The variable parameter employed in different calculation was the total enthalpy of liquid-vapor phase change, h_{LV}, containing two parts: i.e., the sensible heat and the enthalpy of vaporization (i.e., h_{LV}=C×(T−T₀)+Δhᵥₐₚ). In the present experiments, T₀ was the initial temperature of water, i.e., 21° C. T was the vapor temperature measured by the thermometer, which was in the range of 40° C. to 90° C. (see data listed in Table 3 below). In this temperature range, the specific heat capacity of water, C, was a constant, i.e., 4.18 J/g K. However, the enthalpy of vaporization, Δh_{cap}, was highly dependent on the temperature, which was larger at lower temperature. Recent literature employed different values of h_{LV} in their calculation, resulting in certain inaccuracies in the resulting calculated ηₜₕ.

For instance, a first paper directly employed a constant Δhᵥₐₚ at 100° C. (2260 kJ/kg) as h_{LV} to calculate ηₜₕ. Another paper employed a temperature-dependent enthalpy of vaporization Δhᵥₐₚ as h_{LV} to calculate ηₜₕ. These sources did not consider the sensible heat (i.e., C×(T−T₀)). In contrast, another paper considered the sensible heat but employed a constant Δhᵥₐₚ at 100° C. (2260 kJ/kg). By considering these two terms more accurately, the solar thermal conversion efficiencies of the presently-disclosed structure under 1, 3, 5, 7, 10 times concentrated solar illumination were calculated in Table 3. Fortunately, the sensible heat (i.e., C×(T−T₀)) was much smaller than Δhᵥₐₚ, especially under small solar concentration conditions, as shown by the data listed in Table 3. Therefore, previously reported values under 1 sun illumination are still reliable but may contain up to >10% difference under 10× solar concentration.

Thus, for energy conversion efficiency estimation, the sensible heat should be considered since this energy is actually consumed by the vapor. But if one focuses on vapor generation performance, this term can be neglected since it just results in higher temperature vapor rather than generates more vapor.

TABLE 3
Accurate calculation of the solar thermal conversion efficiency.

| | | Vapor | | | |
|---|---|---|---|---|---|
| | \dot{m} | temperature T | C × (T − T₀) | Δhᵥₐₚ | ηₜₕ |
| Copt | (kg/m² · h) | (° C.) | (kJ/kg) | (kJ/kg) | (%) |
| 1 | 1.28 | 41.6 | 86.1 | 2403.3 | 88.6 |
| 3 | 3.66 | 60.4 | 164.7 | 2357.6 | 85.5 |
| 5 | 6.24 | 69.9 | 204.4 | 2333.1 | 88.0 |
| 7 | 9.34 | 76.0 | 229.9 | 2320.7 | 94.5 |
| 10 | 13.30 | 88.9 | 283.8 | 2282.7 | 94.8 |

In addition, this ηₜₕ actually describes the energy consumption in the vapor and has two major components: the energy used for water-to-vapor phase change and the energy used to heat the water/vapor. A larger ηₜₕ does not necessarily correspond to a higher vapor generation rate. For a given value of ηₜₕ, a higher temperature of the generated vapor will actually result in a lower generation rate since more energy is used to heat the water. Therefore, in terms of solar vapor generation rate, it was beneficial to analyze the theoretical upper limit and thermal loss channels in order to estimate the opportunity available for improvement.

### Loss Channels

Recently, a strategy was reported to demonstrate the close to 100° C. steam generation under one sun enabled by a floating structure with “thermal concentration.” A detailed thermal loss analysis was performed, revealing that radiative loss and convective loss were two major thermal loss channels in the solar vapor generation systems. The radiative and the convective losses per area are expressed by Equations (3) and (4), respectively:

$${P}_{rad} = εσ ( {T}_{2}^{4} - {T}_{1}^{4} ) \qquad ( 3 )$$

$${P}_{con} = h ( {T}_{2} - {T}_{1} ) \qquad ( 4 )$$

where ε is the emissivity of the CCP (i.e., 0.98), σ is the Stefan-Boltzmann constant (i.e., 5.67×10⁸ W/(m²·K⁴)), T₂ is the temperature at the surface of the CCP, T₁ is the temperature of the adjacent environment, and h is the convection heat transfer coefficient (assumed to be 10 W/(m²·K)). Using these two equations, it was estimated that the radiative loss from the 100° C. blackbody absorber surface to the ambient environment (20° C.) was ˜680 W/m² and the convective loss was ˜800 W/m². Following this theoretical estimation, when the absorber surface was 44.2° C. (via experimental observation), the radiative loss to ambient was ˜147 W/m² and the convective loss was ˜232 W/m², corresponding to a total of 37.9% energy loss (i.e., 14.7%±23.2%). In this case, it seems that an efficiency ˜90% is impossible. An immediate question is why one can observe a record high vapor generation rate under 1 sun.

To interpret the unique features and physics of the proposed CCP-foam architecture, the thermal environment and heat transfer diagram was analyzed (FIG. 17A). First, the downwards thermal radiation was suppressed. According to the previously reported experimental characterization, the reflection of a 3-mm-thick EPS foam slice was in the range of 40%-60% over the spectral region of thermal emission with ˜10% thermal radiation absorption. Therefore, under thermal equilibrium condition, the temperature of the EPS-foam surface was very close to the bottom surface of the CCP layer so that the downwards radiative loss from the CCP layer was significantly suppressed. Without being bound by any theory, it appeared that the EPS foam employed in some embodiments of the present system served as a thermal radiation shield (in addition to its excellent thermal insulation characteristics), which was superior over previously reported double-sided black systems.

In further analysis of the microscopic thermal environment (FIG. 17B), one can recognize that the CCP surface was covered by a sheet of water and surrounded by heated vapor. Without being bound by any theory, it is believed that the absorbed solar energy of the CCP layer first exchanges thermal energy with water sheet and vapor in this small region rather than directly emitting thermal radiation and exchanging heat with the surroundings through the convection. In many reported experiments to identify the vapor temperature, a thermocouple was usually placed on top of the absorber surface, further demonstrating that the top surface of the absorber was surrounded by heated vapor. Since the temperature of the adjacent environment on top of CCP absorber was very close to the temperature of CCP surface, the radiative and convective loss should be very small. For instance, according to Eqs. (3) and (4), the radiative loss from the 44.2° C. surface under 1 sun to the ˜41.6° C. vapor environment was ˜1.8% and the convective loss was only ˜2.6%. Most absorbed solar energy was still used to evaporate the water sheet on top of the absorber surface rather than lost through these two channels. Without being bound by any theory, it is believed that this is a major physical mechanism for the observed high vapor generation rate. This physical mechanism was not detailed in previous reports.

More importantly, in a real enclosed solar steam system, the vapor cannot be released immediately and the environment inside the system is thermally isolated from the cooler surrounding environment. Furthermore, typical acrylic or glass slabs are opaque to mid-infrared radiation. Consequently, thermal radiation cannot be emitted to the environment. Additionally, convective energy transfers are also largely suppressed when the internal environment is heated under near-thermal equilibrium conditions. In this case, the radiative and convective losses in a real system should be even more negligible. Intriguingly, in a recent report, the highest temperature of the generated steam was observed in a vapor chamber, demonstrating the accuracy of our physical picture.

### Performance for Solar Desalination and the Effect of the Bulk Water Temperature

Conventional desalination technologies are usually energy demanding (e.g., reverse osmosis membrane technology consumes ˜2 kW·h/m³) with serious environment costs. It was estimated that a minimum energy consumption for active seawater desalination is ˜1 kW·h/m³, excluding prefiltering and intake/outfall pumping. Passive solar desalination technologies, such as that of the present disclosure, are particularly attractive due to the electricity-free operation with minimum negative impacts on the environment.

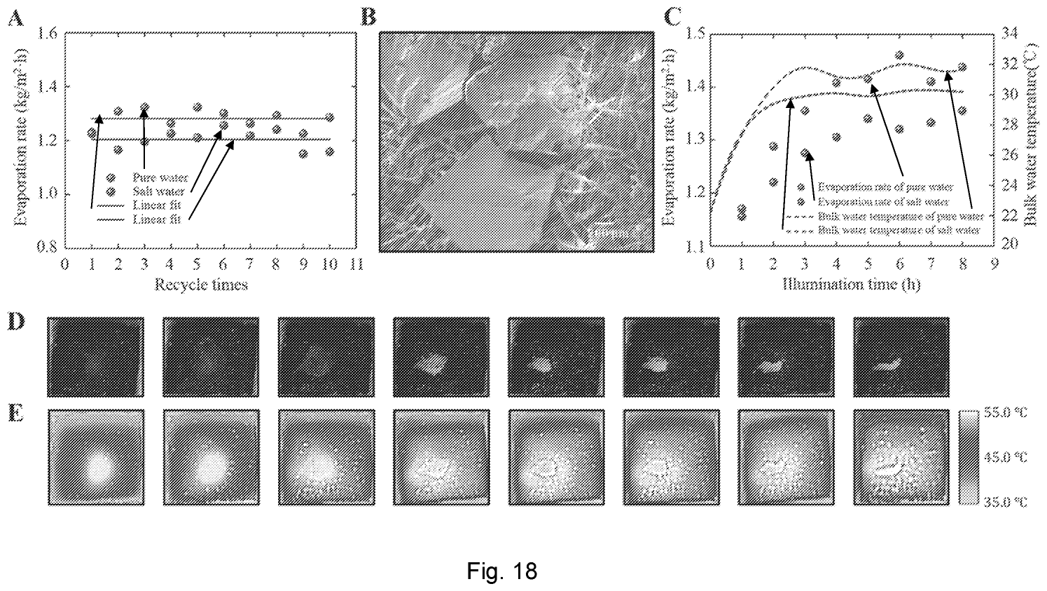

To characterize the evaporation performance and reusability of our CCP-foam for desalination, salt water was prepared with 3.5 wt % NaCl and the solar water evaporation experiment was performed repeatedly. For each cycle, two CCP-foam samples were put on the surfaces of salt water and pure water, respectively, and illuminated under 1 kW/m² for one hour. After that, the CCP samples were dried completely and reused for the next cycle. As shown in FIG. 18A, the evaporation rates of 10 cycles in pure water and salt water (see the arrows) are both stable (i.e., 1.2˜1.3 kg/(m²·h)), demonstrating the reliability of the proposed CCP-foam. Considering the excellent wet and dry strength and autoclavable features of the fiber-rich nonwoven paper (e.g., TechniCloth™ Wiper TX609, available from Texwipe™), it is particularly useful for long term solar desalination application.

After the 1-hour recycling test, a millimeter sized salt crystal was observed on the sample surface (see the first panel in FIG. 18D). Without being bound by any theory, it appears that these white salt particles introduce scattering (see FIG. 18B for SEM image of salt crystal plates on the CCP surface), which should reduce the optical absorption of the CCP sample. An immediate question is whether this salt crystallization will significantly degrade the performance of the vapor generation in practice, which was not mentioned in previous reports.

To investigate this issue, an 8-hour continuous experiment was performed in pure water and salt water in a beaker, respectively. Intriguingly, one can see that the evaporation speeds increased continuously and saturated at the 4^{th}˜5^{th} hour at ˜1.32 kg/(m²·h) and ˜1.42 kg/(m² h) for salt water and pure water, respectively, as shown by the dots connected by the solid lines in FIG. 18C. Since the CCP surface was always wet during the 8-hour test (indicating sufficient water transportation contributed by capillary forces), the salt crystal did not grow further to cover the entire surface. Instead, the salt crystal area even shrank surprisingly, as shown by the photographs of the CCP surface at different time spots (see FIG. 18D). When this experiment was repeated (usually on the next day), this evaporation rate increase was still observed under identical experimental conditions starting from the lower rate, indicating the stable and reusable performance for longer term seawater desalination. As shown by thermal images in FIG. 18E, the average surface temperature of the CCP sample increased from 44˜45° C. gradually and saturated at 53˜54° C. at the 4^{th}˜5^{th} hour. Therefore, the next question is what introduced this surface temperature change.

According to the experimental data shown in FIGS. 14-16, the only observed gradual change is the bulk water temperature, as shown by dashed curves in FIG. 16B. To identify this correlation, the bulk temperature was monitored over 8 hours, as shown by the dashed curves in FIG. 18C (see the arrows). One can see that the bulk water temperature (from 22° C. to 32˜33° C.) and the evaporation rate changed coincidentally. This observation demonstrated that the surface temperature of the CCP-foam is still related to the bulk liquid temperature. The temperature of the bulk water in this experiment reached the thermal equilibrium after ˜5 hours. This may be due to the excellent thermal insulation of the EPS foam support employed in the presently-disclosed structure. Also, it was observed that the salt crystal shrank as the bulk and surface temperature increased (i.e., FIG. 18D). This may be due to the higher solubility of salt in warmer water. This vapor generation performance should improve if better thermal insulation materials are used in the water container for small volume test. On the other hand, if the bulk water temperature change is negligible in larger scale vapor generation applications, one should not expect this obvious evaporation rate change, as is validated in the prototype system demonstration below.

### A Prototype Solar Still System

An exemplary desalination solar still system is illustrated in FIG. 19A(A): A box made by thermal insulating materials is filled by seawater or salty water. A tilted transparent glass covers the box to collect solar light. For conventional solar vapor generation technology, light absorbing materials were usually placed at the bottom of the basin to heat the entire liquid volume with fairly low thermal efficiency (i.e., 30%-40%).

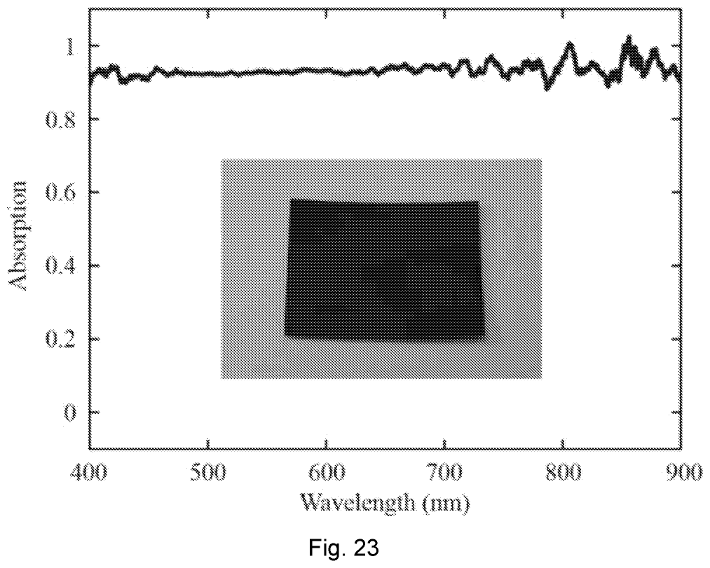

To overcome this weakness, a 5×5 CCP array (FIG. 19A(B)) was developed wherein the array included a 2×2 cm² for each CCP unit with the total area of 100 cm². The array was placed in a polypropylene box (15 cm in diameter with 1500 g water). However, thermal isolating walls were not incorporated in this experiment. According to the thermal distribution measurement, the temperature of CCP surface increased from 18.2° C. (FIG. 19A(C) under dark condition) to 44.6° C. (FIG. 19A(D) under 1 sun illumination). Without being bound by any theory, it is believed that the slight nonuniformity of the temperature distribution (39.5° C. at the comer) in FIG. 19A(D) was introduced by the intensity distribution of the finite size of the light beam. To evaluate its performance, the solar desalination experiment was repeated using this large area sample (FIG. 19A(E)). Meanwhile, two control samples were characterized: (1) a layer of black aluminum foil placed at the bottom of the box (FIG. 19A(F), its optical absorption spectrum is shown in FIG. 23) and (2) salty water with no CCP-foam (FIG. 19A(G)). As shown in FIG. 19B(H), the mass change rate for the CCP-foam array was ˜1.275 kg/(m²·h) (with the estimated thermal efficiency ηₜₕ of 88.2%), which is obviously better than those for control samples (i.e., ˜0.408 kg/(m²·h) with ηₜₕ of 28.2% for the bulk heating strategy, and ˜0.242 kg/(m²·h) with ηₜₕ of 16.7% for the bare salt water evaporation). It was noted that the evaporation rate in this large scale CCP array experiment did not appear to increase. Its bulk water temperature change was also relatively small (20-25° C., as shown by the bottom dashed curve in FIG. 19B(H)). It is believed that this is due to the much larger amount of bulk water, without being bound by any theory. In contrast, the evaporation rates of the two control samples increased slightly, corresponding to their bulk temperature changes, as shown by their respective dashed curves in FIG. 19B(H) (see Description of the Drawings). The net water mass change produced by this 100 cm² CCP-foam structure was 14.5 g after the 5-hour operation, which was ˜25 times of that produced by a single unit (i.e., 0.58 g/h, see FIG. 3). In this case, it was unnecessary to introduce a solar concentrator to enhance the water evaporation rate, which is different from the case for commercial concentrated photovoltaic systems. Due to the extremely low manufacturing cost of the CCP-foam, large area products can easily be realized using commercial paper printing technologies at a price much lower than those for conventional solar concentrators.

As shown in FIG. 19A(I), a complete portable solar still system was demonstrated using an open bottom box (with the 0.01 m² 5×5 CCP-foam array directly in contact with the open water below with buoyancy ensured by foam (represented by dark square visible along the exterior)), shown in the inset of FIG. 19A(I)). The clean water was collected by the distillate channel and guided into a collection bag. This system was then placed on a lake together with a commercial solar still product with an effective area of 0.342 m² (Aquamate Solar Still® (NATO stock no. 4610-99-553-9955) at the retail price of $225), as shown in FIG. 19A(J). It should be noted that the exemplary CCP-array can take the lake water directly while the Aquamate Solar Still® needs to be actively fed. It is believed that the Aquamate Solar Still® uses the conventional solar still principle of heating bulk water. The Aquamate Solar Still® does not use the presently-disclosed CCP-foam arrangement. It is likely that there are other differences between the systems, but the Aquamate Solar Still® is a closed system, so its contents cannot be readily ascertained. After a 10-hour operation in the outdoor environment on a sunny-cloudy day with varying sun light illumination conditions (see FIG. 19B(K) for temperature and sun light intensity distribution), generation productivities of 0.832 kg/(m²·day) and 0.344 kg/(m² day) were obtained for these two systems, respectively. The performance of the CCP-foam system is ˜2.4 times of the Aquamate Solar Still®. In addition, due to a scattering of mist formed on the cover (FIG. 19A(J)), the input light decreased significantly. Performance may be improved by the use of a non-toxic, super-hydrophobic surface treatment on the transparent glass cover of embodiments of the present disclosure. The prototype did not include corrugation or an air gap between the substrate and the support.

### Cost Estimation and Comparison

Considering the key components for solar-to-heat conversion employed in previously-reported literature (e.g., metal nanoparticles or nanorods dispersed in water, metal nanoparticles on nanoporous anodic alumina, exfoliated graphite on porous carbon foam, a selective absorber inserted between a polystyrene foam disk and a bubble wrap), the cost of embodiments of the presently-disclosed structure is the low. In FIG. 19, a complete system was demonstrated using low cost plastic plates. It is well-known that the cost for plastic products are extremely low. However, the cost for condensate collection and other components are required by all solar still systems, which was not discussed in recent literature. According to a review article published in 2007, the net cost of materials for conventional solar still is ˜$185.2/m². In contrast, the system shown in FIG. 19 is only $76.45/m² based on the small scale retail price for all materials/components (see Table 4 below). It is noted that the major cost was for the acrylic slabs, and that these slabs can be replaced by lower cost plastic boxes to reduce costs even further. The net cost for mass production will be significantly lower.

TABLE 4
Cost of a prototype solar still system (1 m²)

| | Unit price | Amount | | Cost |
|---|---|---|---|---|
| Carbon black | $2.26/lb | 100 | g | $0.50 |
| Fiber-rich paper | $1.05/m² | 1.5 | m² | $1.58 |
| EPS foam | $0.59/m³ | 0.5 | m³ | $0.30 |
| Acrylic slab | $31.20/m² | 2.31 | m² | $72.07 |

| | | | |
|---|---|---|---|
| Collection bag | $2/each | 1 | $2.00 |
| | | Total | $76.45 |

### Additional Discussion

### Introduction

Approximately 75% of the Earth surface is covered by water. However, among this abundant natural resource, fresh water occupies ˜2.7% only. Over 97% of the water are in oceans and seas, containing salts and minerals that cannot be consumed directly in our daily life. Fresh water scarcity is one of the most pressing challenges faced by human. Therefore, desalination is the major technology to convert seawater to fresh water for drinking, irrigations and daily consumptions. The mainstream technology, reverse osmosis (RO), can extract fresh water from seawater by consuming huge amounts of electricity that is responsible for the emerging global warming effect. The energy consumption of the RO system is directly proportional to the salinity of the seawater. In addition, discharging hypersaline brines into adjacent large water bodies will cause health hazards to the local marine life and are not environmentally safe. As a result, the economic and environmental costs of desalination plants continue to pose challenges in implementing these systems. Recently, solar-driven interfacial evaporation received extensive attention due to their potentials in water, energy and environmental sustainability. This technique evaporates water from brines or contaminated water using solar thermal effects and is promising to realize zero-liquid-discharge (ZLD) desalination. In the past decade, researchers developed various advanced materials, improved thermal management strategies and systems, and cooling technologies to improve the overall water productivity. Competitions in higher energy conversion efficiency and evaporation rates, lower manufacturing costs and less maintenance requirements are major goals. However, technical challenges suffered by conventional membrane technologies for RO (e.g., fouling) are still faced by solar desalination technologies.

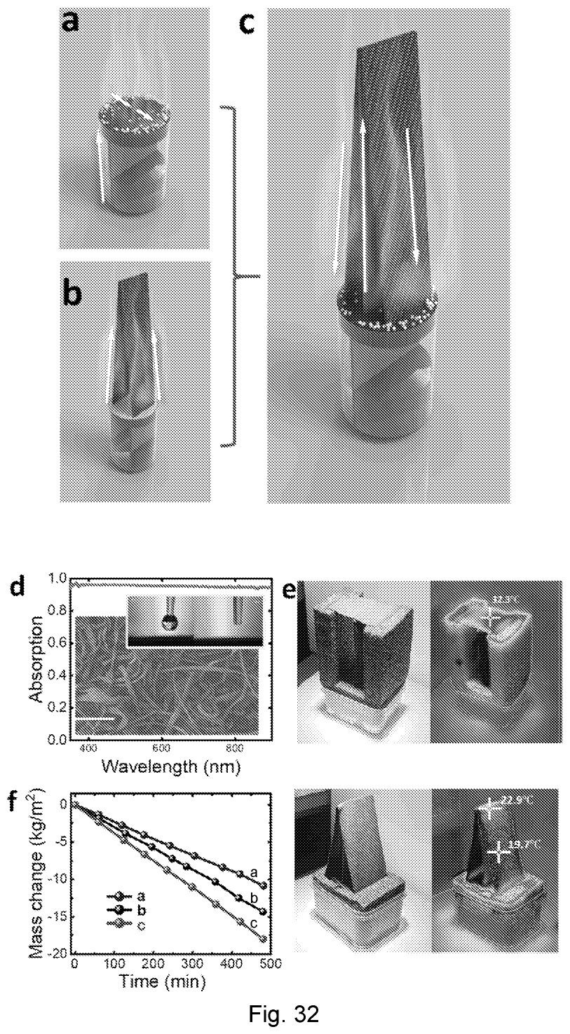

When seawater is evaporated under the sun using an evaporator, a salinity gradient is formed between the bulk water and the evaporator, allowing the diffusion of the salt ions from the top photothermal layer to the bulk water. Salt accumulation on the solar absorber is considered generally undesirable as solar absorbers are mostly black to enable maximum absorption of the sunlight. Formation of salt on the absorber hinders stable vapor generation and gradually deteriorates the solar thermal performance. Recently, self-cleaning strategies were proposed to minimize the maintenance requirement for solar vapor generation (e.g., using pre-wetting, wood, and specially designed geometry structures. FIG. 32a shows a representative architecture using a controlled water flow to guide the salt transportation within the evaporative materials (e.g., so called the edge preferential salt crystallization). Due to the salt concentration increases along the water flow direction, the salt crystals precipitate at the outer ring of the planar evaporative surface. By connecting the evaporator to an expandable polyethylene (EPE) foam, those salt crystals were moved to the foam outside the evaporator. Using this type of guided water flow strategy, solar-driven evaporation rates of 1.42˜2.43 kg m⁻² h⁻¹ were obtained experimentally with minimum requirement in maintenance to regenerate the evaporative surface. The next question is how to enhance the evaporation rate of this type of water-flow-driven self-cleaning strategy since the evaporation rate is proportional to the salt precipitation speed. For instance, under regular 1 sun illumination, evaporation rates up to 2.2 to 3.1 kg m⁻² h⁻¹ have been experimentally demonstrated using tapered evaporation architecture and advanced hierarchy materials, much higher than other planar solar evaporation structures. However, in these experiments, fresh water was used as the test bed. If brines are used as the source water, the fouling of nano/micro-pores is expected to deteriorate the performance of solar desalination. Recently, several strategies were proposed to minimize this fouling issue in various solar evaporation structures. For instance, a stable evaporation rate of 2.42 kg m⁻² h⁻¹ was demonstrated using a tetragonal cup shaped architecture by adding salt inhibitor, nitrilotriacetic acid (NTA) into the brines. However, the chemicals added to change the nature of growth of the salt crystals may post an additional cost barrier for large scale desalination of seawater.

This article will disclose a self-salt-cleaning architecture to address these challenges. Building on top of our previously disclosed architecture for cold solar vapor generation, a maintenance-free operation over 4 days was demonstrated using a hypersaline brine with the salinity of 20 wt %. Due to the improved water transportation engineering, accumulated salts were guided through predesigned pathways, which will not block the evaporative surfaces or the pores. According to our experiment, a stable evaporation rate over 2.6 kg m⁻² h⁻¹ was obtained over a 4-day test in the laboratory. Outdoor tests demonstrated much higher evaporation rates (e.g., up to 9.1 kg m⁻² h⁻¹) due to the natural wind contribution (e.g., at the peak speed of 3.2 m s⁻¹). This architecture provides a new and powerful strategy to treat hypersaline water from RO systems and complete a ZLD cycle for future desalination and salt mining technologies.

### 2. Materials and Methods

### 2.1 Evaporation Architectures

FIG. 32b shows a tapered evaporation architecture disclosed in our recent report: Under regular 1 sun illumination, the surface temperature of this architecture is close to or even lower than the ambient temperature due to the decreased solar energy density on the larger surface. As a result, the incident solar energy was mainly used to convert liquid water to gas-phased moisture rather than heat the vapor. In particular, when the surface temperature is below the ambient, the evaporation system will take extra energy from the environment, instead of losing thermal energy to the ambient. The produced vapor is close to or even lower than the ambient temperature (i.e., so-called cold vapor generation). According to our previously reported experiment, an evaporation rate over 2.2 kg m² h⁻¹ was obtained under 1 sun illumination (a similar concept was also disclosed independently by ref.). Building on this design, here we combine the controlled water flow strategy with this tapered evaporation architecture to demonstrate a self-salt-cleaning system using an “umbrella” architecture. As illustrated in FIG. 32c, the water is transported from a central vertical channel to the top surface. Then the water will flow down through the two wings which do not touch the bulk water body. Following the structure reported in X Wang, Q Gan, R Chen, H Peng, T Zhang, M Ye. Water delivery channel design in solar evaporator for efficient and durable water evaporation with salt rejection. ACS Sustain Chem Eng 2020; 8:7753-7761, we also introduced an EPE foam around the evaporator to collect the crystalized salts. Therefore, the water within the evaporative material will flow towards these two dead ends, evaporate and finally left salts at the surface of EPE foams, rather than at the surface of the evaporative material in the tapered architecture shown in FIG. 32b (see details under the heading S1: Salt water evaportation below). In this case, the water-flow-induced self-cleaning strategy should also work for this limit-breaking cold vapor generation architecture. To validate this hypothesis, we developed a flat (i.e., FIG. 32a), a tapered edge to center triangle (i.e., FIG. 32b), and an “umbrella” evaporation system (i.e., FIG. 32c; also see the side-view photos of the three architectures under the heading S2: Water transport pathways below) using carbon-coated fabric (CCF) as the evaporative surfaces. This CCF was fabricated using durable hydrophilic materials (Texwipe-609@) (see the upper inset in FIG. 32d for the evidence of its hydrophilic feature). Its averaged porosity is ˜66.9% (see the lower inset of FIG. 32d for its microscopic image, and the calculation details under the heading S3: Calculation of porosity of CCF below).

### 2.2 Characterization

The optical absorption of the CCF was characterized using an integrating sphere spectrometer (Model IS200 Series Integrating Spheres, Thorlabs). As shown in FIG. 32d, this porous fabric can absorb over 97% solar light. Under 1 sun illumination, the top surface of the flat system reaches ˜32° C. (the upper panel in FIG. 32e), while the “umbrella” surface is only at 19˜23° C. (the lower panel in FIG. 32e), below the ambient temperature of −24° C. The thermal images were characterized using FLIR ONE Pro®. The weight loss of the water beaker was measured using an electronic weighing scale (Adam EBL 314i Eclipse® Analytical Balance, with a resolution of 0.1 mg). As shown in FIG. 32f, the evaporation rates of the tapered (i.e., FIG. 32b) and the “umbrella” system (i.e., FIG. 32c) are ˜2.0 and ˜2.5 kg m⁻² h⁻¹, respectively, much larger than that of the flat system (i.e., 1.6 kg m⁻² h⁻¹). These three evaporation rates for fresh water will serve as the baseline of the evaporation experiment for salt water.

### 3. Results and Discussion

### 3.1 Salt-Water Evaporation

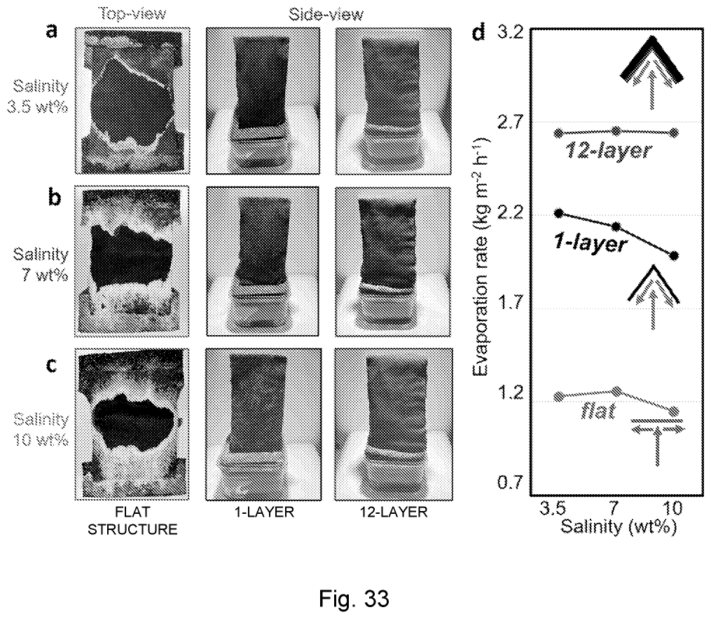

Next, we introduced salt water to characterize the solar-driven evaporation rates of the flat structure and the proposed “umbrella” structures with 1-layer and 12-layers in the two wings. The salinity of the water was increased from 3.5 wt % (FIG. 33a) to 7 wt % (FIG. 33b) and 10 wt % (FIG. 33c), respectively. One can see from the top surface of the flat structure that the salt crystalized at the outer edge of the evaporator structure. In particular, the central clean area percentage shrinks from 55.2% (FIG. 33a) to 35.3% (FIG. 33c) as the salinity increases. According to previously reported investigation, the shape and area of the central clean region is determined by the water diffusion pattern on the flat evaporative surface. The evaporation rates on this flat surface range from 1.23 kg m⁻² h⁻¹ to 1.16 kg m⁻² h⁻¹ for those three salinities, respectively (see FIG. 33d). In contrast, as shown by the second column in FIGS. 33a-33c, the salt accumulation issue was largely addressed using the umbrella structure with 1-layer wings: After 10-hour solar-driven evaporation, the best evaporation rate of the 1-layer umbrella architecture was 2.21 kg m⁻² h⁻¹ (see the first black sphere). For the 7 wt % salt water, approximately 9.0% of the surface area was occupied by crystalized salts (see the second column in FIG. 33b), much smaller than the salt occupancy percentage of 57.0% on the flat surface (see the first column in FIG. 33b). Intriguingly, this salt accumulation issue was completely removed in the 12-layer structure, as shown in the third column in FIG. 33b. No clear salt crystals were observed on this 12-layer structure after 10-hour continuous operation. The best evaporation rate for the 12-layer structure reached 2.66 kg m⁻² h⁻¹ (see second marker), representing one of the best reported evaporation rates under 1 sun illumination. When we further pushed the salinity to 10 wt % and performed the same 10-hour operation, the salt occupancies on the flat and 1-layer umbrella structures are 64.7% and 12.6%, respectively (as shown in FIG. 33c). The evaporation rate of the 1-layer structure decreased as the salinity increased from 7 wt % to 10 wt % (see black spheres) due to the salt coverage. In contrast, the evaporation rate of the 12-layer umbrella structure is still over 2.65 kg m⁻² h⁻¹ due to no obvious salt crystallization, as shown in FIG. 33d. This intriguing observation should be interpreted by the local salinity saturated on the umbrella structure, resulting in the crystallization on two wings of the umbrella structures. Importantly, the self-cleaning functionality is heavily dependent on the water transportation capability of the evaporative material. A larger water transfer capability is desired to minimize the salt accumulation and fouling issues for solar-driven interfacial evaporation, as will be revealed in the next section.

### 3.2 Water and Salt Transport Process

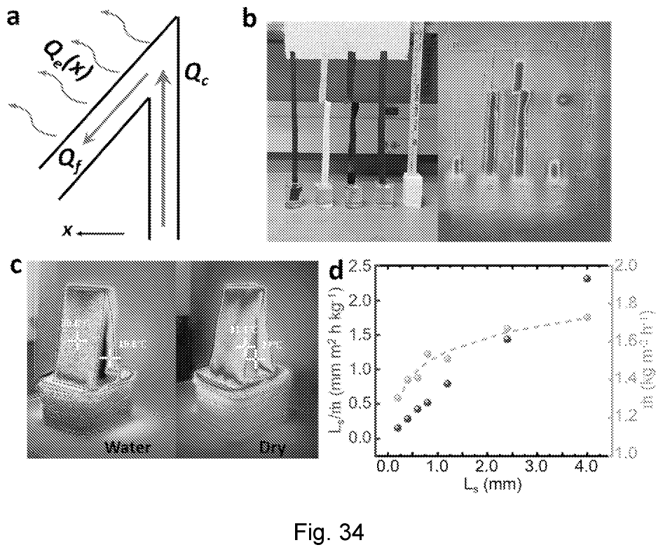

General process: As illustrated in FIG. 34a, the water was transported to the top surface by the central fabric due to capillary force (i.e., at the rate of Q_{c}). This is the water transfer mechanism of natural plants/trees, which was also used in previously reported evaporative architectures. After that, the water will flow down along the wing at the rate of Q_{f} and evaporate at the rate of Q_{E} simultaneously. The salt will not crystalize until the local salinity saturates. Therefore, the surface salt accumulation is determined by the water transportation capability (i.e., Q_{c} and Q_{f}) and surface evaporation along the wings [i.e., Q_{E}=∫Qₑ(x)]. For water evaporation applications, a large surface evaporation rate, Q_{E}, is always desired. Therefore, to prevent the salt accumulation, the general target is to maximize the water flow rates (e.g., Q_{c} and Q_{f}) to lower the local salinity. In addition, when the lower end of the wing is higher than the bulk water surface, no water can flow out from the capillary of the wings (i.e., Q_{f}=0 at the two dead ends) due to the first law of thermodynamics. One cannot transport water from a lower position to a higher position without external energy supplies. Therefore, when the water diffused into the two wings and filled their water storage capacities, the ultimate input flow is determined by the total surface evaporation Q_{E}, i.e., Q_{c}=Q_{E}. Compared with the flat structure shown in FIG. 32a, the umbrella architecture introduced larger surface areas for enhanced Q_{E}. Under the same solar illumination condition, the surface temperature on the two wings is closer to the ambient temperature (e.g., 19 ˜23° C. as shown in FIG. 32e), enhancing Q_{E} further. Therefore, the downward water flow Q_{f} at a local position on the wings is also increased accordingly, resulting in a lower local salinity for the umbrella architecture than the flat structure (which was validated by FIG. 33). Ultimately, the EPE foam connected to the dead ends of the two wings provided an output port to release salts, enabling a balance in salt transfer. It was observed that the salts accumulated on EPE foams connected to the end of the evaporative wing during a 3-hour continuous operation. Following this interpretation, a better umbrella architecture for self-cleaning functionality requires a larger Q_{c} capability.

Water transportation capability: To select the best material for water transportation from the bottom to the top surface (i.e., to maximize Q_{c}), we employed infrared imager to directly observe this anti-gravity process. As shown in FIG. 34b, we selected 4 samples hung vertically (i.e., ProCool Athletic Pique®, Texwipe 609 ®, CCF, and Highland fabric (highlandindustries.com/products)) with the lower-ends dipped into the fresh water and took their thermal image to compare the water transportation height. It was observed that that the CCF realized the highest water transportation height as well as the transportation speed, revealing its superior performance as the vertical water channel. An intriguing question is: what is the water transportation capability of this vertical channel? Here we designed a new experiment to quantitatively characterize this upper limit for Q_{c}. In FIG. 34c, the incident light intensity was increased to control the surface temperature and the evaporation rate of the umbrella structure. The upper limit of Q_{c} can be determined when the wet surface was dried completely. According to our previous earlier investigation, the surface temperature of the wet surface is lower than the dry surface under the same solar illumination condition due to evaporative cooling. Therefore, the completely dry condition can be determined when the temperature of the evaporation surface (the left panel) is similar to that of a dry surface (the right panel) under the same solar intensity. In our experiment shown in FIG. 34c, this condition was met under the illumination of 4-sun (i.e., ˜4000 W m⁻²) for 1-layer of CCF for the vertical water transportation. As a result, the measured upper limit of the central water transportation channel is 15.2 g h⁻¹ for this 1-layer of CCF with the cross-sectional area of ˜11.0 mm². Under 1 sun illumination, the measured total amount of the evaporated water is 5.4˜6.1 g h⁻¹. One can see that the upper limit for Q_{c} of the 1-layer CCF is much larger than the amount of water evaporated by the entire umbrella structure under 1 sun illumination. Consequently, the salt crystallization is not limited by Q_{c}. On the other hand, as illustrated by FIG. 34a, the local surface evaporation, Qₑ(x) will result in a spatial gradient of the salinity. The local salinity of the water flow is increasing towards the lower part of the wing. Therefore, the salt crystallization is actually determined by the salt capacitance of the wing films, as will be discussed next.

Salt capacitance of the top wings: According to a previously reported salt capacitance model for salt rejecting processes, increasing the thickness of the evaporative layer for a given architecture is able to prevent salt fouling by extending the transient salt charging time, tₛ. This salt charging time (tₛ=Cₛ/mₛ) describes the amount of time taken for a particular solar absorber film to attain saturation salinity. In this equation, Cₛ is the salt capacitance, described by Cₛ=ρ_{w} (Cₛₐₜ−C_{∞})·Lₛ. Here ρ_{w} is the water density (i.e., ˜1000 kg m⁻³); Cₛₐₜ is the mass fraction of salt to water in saturated brine; C_{∞} is the mass fraction of salt to water in bulk water; Lₛ is the capacitance layer thickness. mₛ is the salt accumulation rate which is described by mₛ=\dot{m}C_{∞}/(1−C_{∞}), where i is the averaged evaporation rate (i.e., in the unit of kg m⁻² h⁻¹). Following this equation, tₛ is proportional to Lₛ/h. One of the simplest strategies to enhance the salt capacitance is to increase the film thickness Lₛ if h will not increase proportionally. Therefore, the improved salt-cleaning feature from 1-layer structure to the 12-layer structure observed in FIG. 33 agrees well with this strategy. In FIG. 34d, we characterized the overall evaporation rate m under 1 sun illumination by changing Lₛ only [i.e., from 1 layer (0.2 mm) to 20 layers (4 mm)] for a given umbrella architecture (with two layers of CCF for the vertical water transfer channel). One can see that \dot{m} did not increase linearly with Lₛ(see light gray spheres in FIG. 34d). Instead, it approaches a rate of ˜1.73 kg m⁻² h⁻¹ when L_{S}=4 mm (see the dashed fitting line to the measured results). We also plotted the values of measured Lₛ/m to reveal the trend of salt charging time (see black spheres). As a result, increasing the capacitance layer thickness Lₛ cannot improve the solar-driven evaporation rate indefinitely but can increase the salt charging time (i.e., prevent salt accumulation). Based on this understanding, next, we selected 16 layers of CCF as the top wings to demonstrate the practical solar-driven evaporation.

3.3 Self-Salt-Cleaning Architecture for Hypersaline Brines with the Salinity of 20 wt %

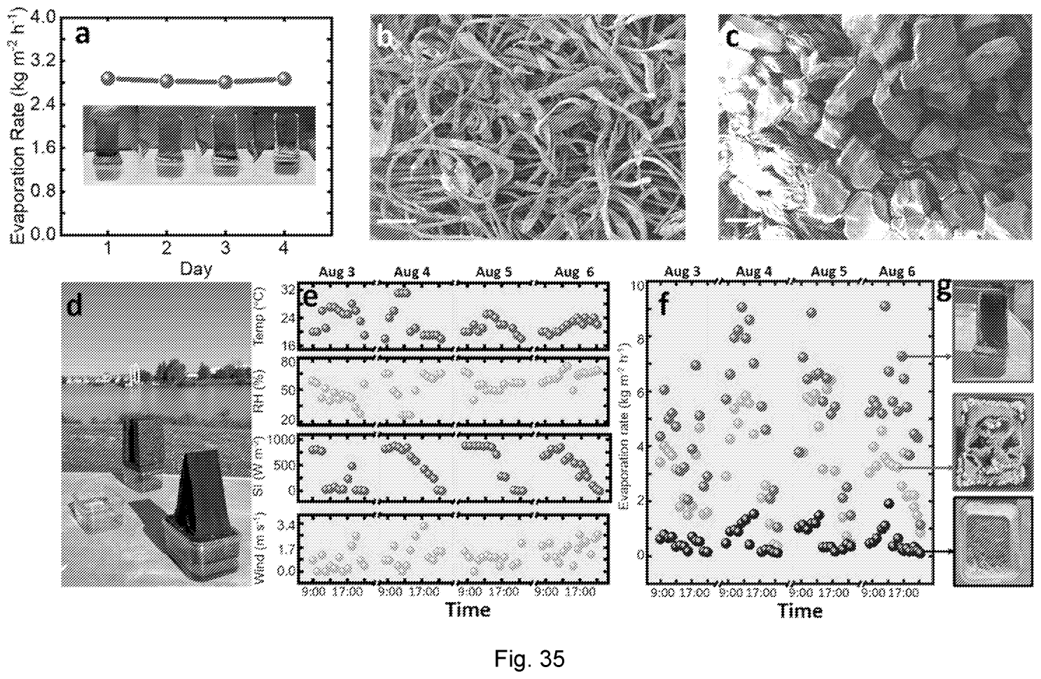

Conventional membrane-based RO technologies mostly suffered from fouling issues for high saline seawater. Importantly, discharges of these hypersaline brines from RO desalination plants will introduce significant issues to local environments, including local water contamination, air pollution and consumption of electricity. Here we employ hypersaline brine with the salinity of 20 wt % to demonstrate the superior self-cleaning feature of the proposed umbrella architecture for solar-driven evaporation. Insets of FIG. 35a show the photos of the structure after 10-hour operation under 1 sun illumination for 4 days. The evaporation rate stabilized in the range of 2.80˜2.90 kg m⁻² h⁻¹. One can see that more and more salts accumulated on the edges (e.g., Day 3) and lowers parts of the CCF surface (e.g., Day 4). These accumulated salts strongly stick to the CCF wing surfaces, indicating the difficulty for regeneration of the solar evaporation surfaces. As shown by the SEM image of the contaminated surface in FIG. 35b, these salts strongly mixed with the carbon powder on the fabric microstructure, which was difficult to remove mechanically. One will have to dissolve these salts in low salinity water to regenerate the CCF surfaces. To address this salt diffusion issue, we then introduced one more layer of structured fabric (Highland Industry®) on top of the CCF layers and then performed the identical experiment. With this top layer, the surface evaporation rate was increased slightly. Interestingly, larger salts crystals were obtained on this structured fabric as shown in FIG. 35c. Remarkably, those salt crystals only cover the top surface of this structured fabric, which can be removed easily. This promising result indicates that designed microstructures are able to control the salt crystallization further, which is still under investigation.

Finally, we placed this umbrella structure, a flat structure and a beaker of 20 wt % salt water in an outdoor environment at Buffalo, NY to perform the field test (FIG. 35d). Compared with the laboratory experiment, outdoor test will be strongly affected by natural wind, which will change the evaporation rate significantly. The environmental conditions are plotted in FIG. 35e, showing the ambient temperature, relative humidity, solar intensity and wind speed over 4 days. The weight losses of the three systems were measured once an hour during daytime to record their evaporation rates. As shown in FIG. 35f, the highest evaporation rate of the umbrella structure can reach ˜9.05 kg m⁻² h⁻¹ due to the natural wind contribution (at the peak speed of ˜3.2 m s⁻¹). In contrast, the peak evaporation rates for the other two systems are ˜5.89 kg m⁻² h⁻¹ (the flat architecture) and ˜1.91 kg m⁻² h⁻¹ (the bare beaker) under the same environmental condition. After the 4-day field test, over 90% surface area of the flat architecture was occupied by salt crystals (see the central panel in FIG. 35g). Remarkably, salts only crystalized at edges of the umbrella structure, as shown by the upper panel in FIG. 35g. Most salt crystals accumulated at the EPE foam surface and were easy to remove mechanically. Intriguingly, due to the significantly enhanced evaporation rate, the umbrella structure evaporated much larger amount of water than the other two systems under identical weather conditions: i.e., after the 4-day operation, the total evaporated water was 837.4 g from the umbrella structure, 520.6 g from the flat structure and 226.4 g from the control bare beaker, respectively. The “umbrella” structure evaporated ˜3.7x water as much as the control bare beaker. This experiment demonstrates the potential of the proposed umbrella architectures for accelerated salt mining applications that were conventionally produced by solar- and wind-driven evaporation processes.

### Further Experimental Results

### Comparative Performance of Structures

We compared the evaporation rates and the salt occupancies of the structures a, b and c, using 7 wt % brine solution under 1-sun illumination for 10 h.

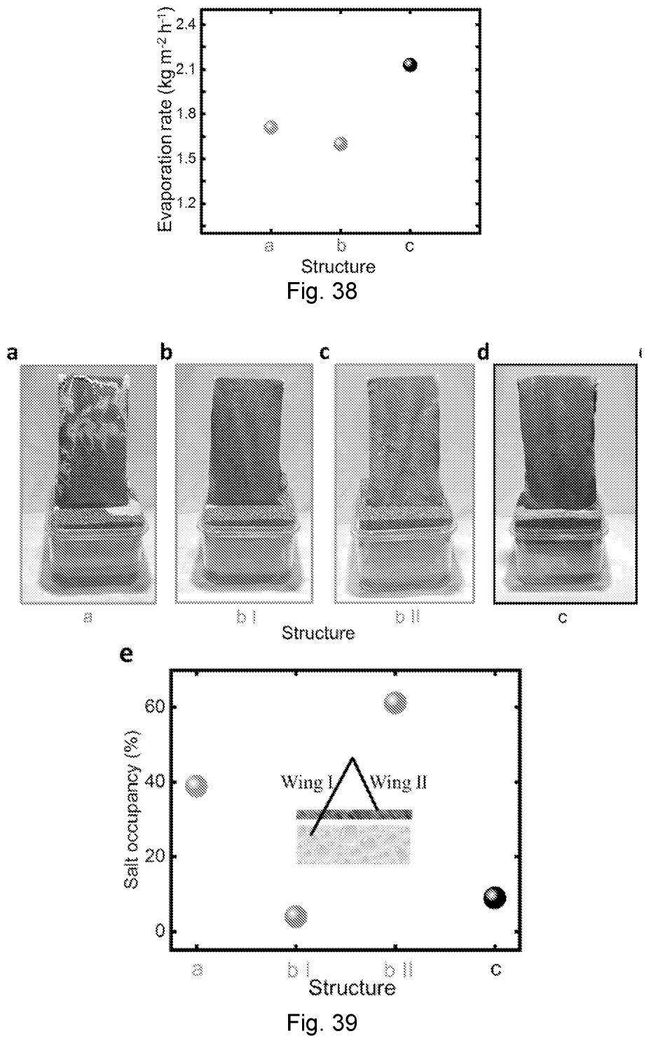

As shown in the FIG. 38, the evaporation rates of the structures a, b, and c were ˜1.71 kg m⁻² h⁻¹ (left dot), ˜1.60 kg m⁻² h⁻¹ (middle dot), and ˜2.13 kg m⁻² h⁻¹ (right dot), respectively. The evaporation rate of the umbrella structure (i.e., structure c) is the largest, which is 1.25× and 1.33× faster than structures a and b, respectively.

The surfaces of the structures a, b, and c are shown in FIGS. 39a-d. Structure b is asymmetric, and therefore we define the wing that touches the brine solution as Wing I, and the other wing as Wing II, as shown in the inset of FIG. 39e. After 10-h illumination, the salt occupancies of structures a, b, and c were ˜38.9%, ˜32.6% (i.e., ˜4.0% for Wing I, ˜61.2% for Wing II), and ˜9.0%, respectively (the dots in FIG. 39e from left to right, respectively). Although the salt occupancy for Wing I is low (i.e., ˜4.0%), the high salt occupancy for Wing II (i.e., ˜61.2%), due to the long water transportation path, results in the high averaged salt occupancy (i.e., ˜32.6%) for structure b. The umbrella structure (i.e., structure c) shows the best performance: the smallest salt occupancy of ˜9.0%.

Determining Performance of Structures with Various Parameters

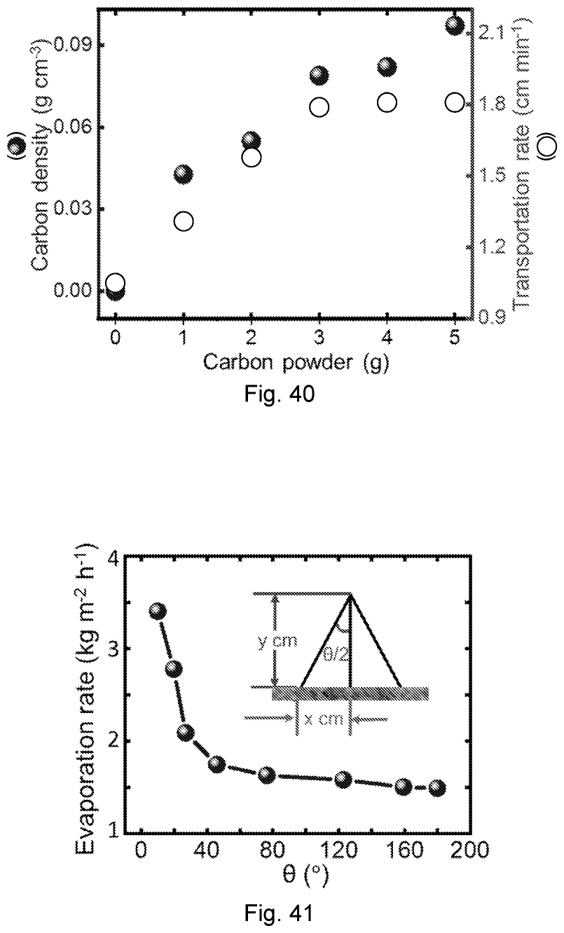

To compare the capillary effect, we hung the samples vertically with the lower-ends dipped into the fresh water and monitored the water diffusion speed. Then, we calculated the water transportation rate (i.e., the water transportation height per minute) in 11 min (white dots in FIG. 40). When more carbon powder was coated, i.e., carbon density increased from 0 (white paper) to 0.079 g/cm³, the water transportation rate increased from −1.05 cm min⁻¹ to ˜1.79 cm min⁻¹, indicating better capillary effect. However, there is a limit on the enhancement of more carbon powder to the capillary effect. One can see that when the carbon density was 0.097 g/cm³ (i.e., 5-g carbon powder was used), the water transportation rate only slightly rose to 1.81 cm min⁻¹.

TABLE 5
Parameters for the umbrella structures
shown in the inset of FIG. 41

| Half-width (x cm) | Height (y cm) | Apex Angle (θ deg) |
|---|---|---|
| 2.75 | 0 | 180.0 |
| 2.75 | 0.5 | 159.4 |
| 2.75 | 1.5 | 122.8 |
| 2.75 | 3.5 | 76.3 |
| 2.75 | 6.5 | 45.9 |
| 2.75 | 11.5 | 26.9 |
| 2 | 11.5 | 19.7 |
| 1 | 11.5 | 9.9 |

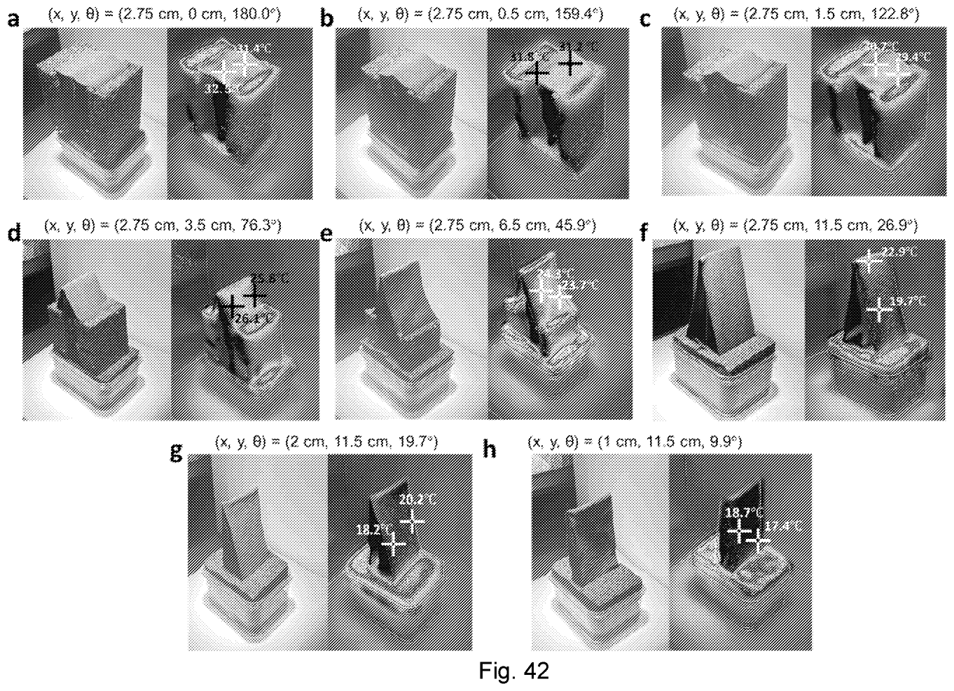

Photos and thermal images of the structures are shown in FIG. 42. It can be seen that the surface temperature decreased from higher than 30° C. to lower than 20° C. when the evaporation rate increased.

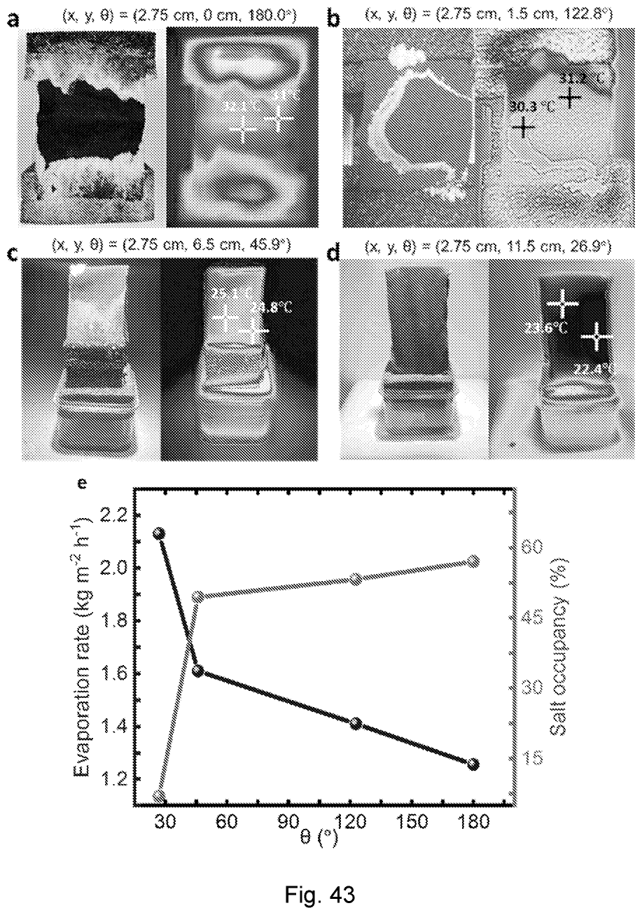

Moreover, we selected 4 structures to investigate the salt occupancy using 7 wt % brine solution under 1-sun illumination for 10 h. The structure parameters and the salt accumulation are shown in FIG. 43a-43d. Similar to the results in FIGS. 41 and 42 (in which we used fresh water), with smaller apex angle, the evaporation rate increased, accompanied by lower surface temperature and salt occupancy (FIG. 43e).

In sum, the structure with smaller apex angle lead to better performance: faster evaporation rate and smaller salt occupancy. The optimized apex angle should be similar for the TeePee structure.

### Carbon Impregnation

The carbon coating process is described below:

2 g carbon powder [Orion with particle sizes ranging from 10 to 30 nm (https://www.orioncarbons.com/production_processes)] was dispersed into 400 mL water. 8 mL acetic acid was added to make carbon powder easier to attach to the paper. The solution was mixed in a 1000 ml beaker and blended well using an ultrasonic cleaner (VIVOHOME PS-30A) for 5 min. Subsequently, the prepared white paper (Texwipe-609, with a dimension of 60 cm×2 cm×0.02 cm) was put into the mixed solution to vibrate and stir for 3 minutes so that carbon powders can dye the paper uniformly. After that, the carbon coated paper was dried at 80° C. on a heating stage. This procedure was repeated three times to realize the ideally dark color.

To determine the optimal combination, we adopted different amount of carbon powder to disperse, from 0 g (i.e., white paper without carbon coating) to 5 g, which lead to a carbon density (i.e., the weight of carbon powder per unit volume of paper) increase from 0 to 0.097 g cm⁻³, represented by the black spheres in FIG. 40.

To compare the capillary effect, we hung the samples vertically with the lower-ends dipped into the fresh water and monitored the water diffusion speed. Then, we calculated the water transportation rate (i.e., the water transportation height per minute) in 11 min (white circles in FIG. 40). When more carbon powder was coated, i.e., carbon density increased from 0 (white paper) to 0.079 g/cm³, the water transportation rate increased from −1.05 cm min⁻¹ to ˜1.79 cm min⁻¹, indicating better capillary effect. However, there is a limit on the enhancement of more carbon powder to the capillary effect. One can see that when the carbon density was 0.097 g/cm³ (i.e., 5-g carbon powder was used), the water transportation rate only slightly rose to 1.81 cm min⁻¹.

### 4. Conclusion

In conclusion, in this article, we reported an “umbrella” architecture for solar-driven interfacial evaporation that can produce cold vapor and prevent the evaporative surface from salt accumulation. Compared with flat structures that were widely used in most solar evaporation literature, the umbrella architecture contains a much larger surface area, corresponding to a much lower solar power densities on its wings. Under 1 sun illumination, the best evaporation rate of 2.66 kg m⁻² h⁻¹ was obtained in the laboratory condition. Because of the controlled water flow direction from the central vertical channel to the top wings, its water and salt transfer mechanisms were analyzed. It was revealed that sufficiently large water transfer capability and salt capacitance are key factors to minimize the local salt saturation. Both indoor and outdoor experiments were performed to show the maintenance-free solar-driven evaporation for hypersaline brines with the salinity of 20 wt %. Due to the wind-induced evaporation, the peak evaporation over 9 kg m⁻² h⁻¹ was observed on the “umbrella structure”. After a 4-day continuous outdoor test, the total evaporated water by the “umbrella” structure is approximately 3.7× higher than the bulk water evaporation. Remarkably, most salts crystalized at the area outside the evaporative surfaces, which is easier for salt collection. This type of simple and inexpensive “umbrella” architecture is promising to pave the way towards ZLD desalination and accelerated salt mining technologies.

### S1. Salt Water Evaporation

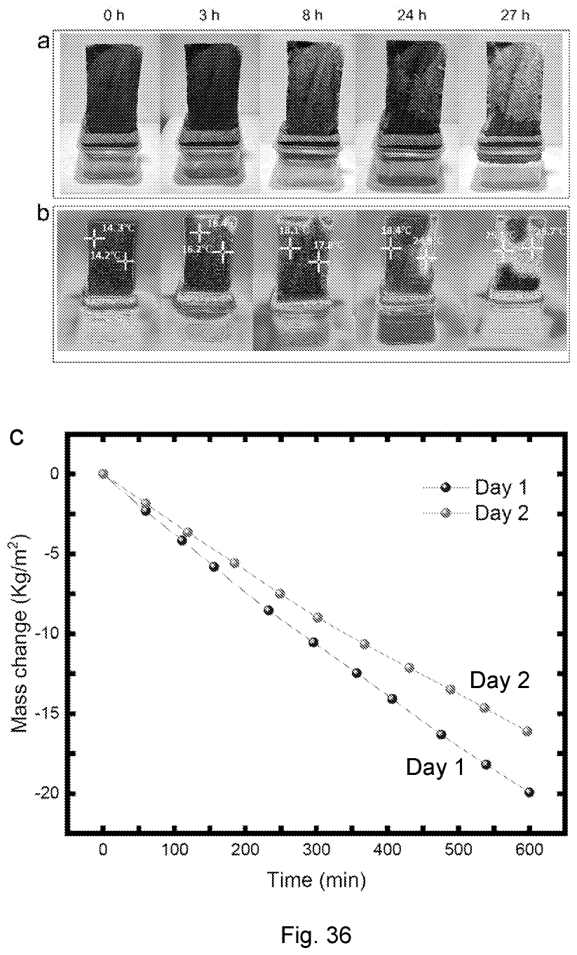

The tapered architecture shown in FIG. 32b was placed under 1 sun illumination for two days (10 h/day for solar evaporation and 14 h/day for dark evaporation). The salinity of the bulk water was 3.5 wt %. FIG. 36a shows the salt accumulation on this 1-layer structure. In this architecture, the water is transported from the two wings to the top. Without the controlled water flow strategy in FIG. 32c (i.e., the water is transported from a central vertical channel to the top surface, and then down through the two wings), one can see the salt accumulation on the surface of the evaporator after 8 h, much more obvious than that on the umbrella structure after 10-h illumination (center panel of FIG. 33a). After 27-h operation, the salt occupancy percentage reached 79% on the structure. The salt accumulation resulted in a surface temperature increase from ˜14.2° C. to ˜25.1° C. (FIG. 36b), and a decrease of the evaporation rate from ˜2.20 kg m⁻² h⁻¹ to ˜1.46 kg m⁻² h⁻¹ (FIG. 36c). This experiment indicates that the water delivery path plays an important role in salt accumulation.

### S2. Water Transport Pathways

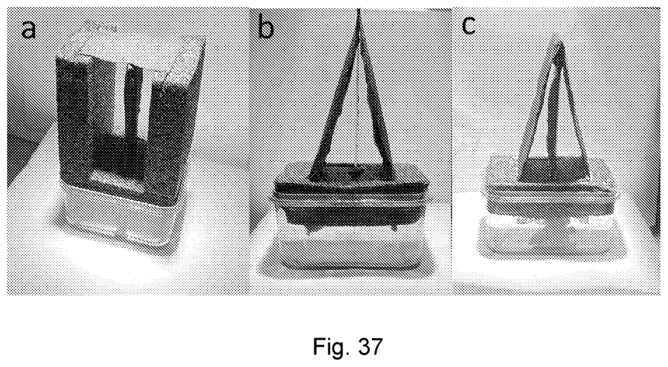

FIG. 37 shows the side-view photos of the three architectures in FIGS. 32a-c: the flat (FIG. 37a), the tapered triangle (FIG. 37b), and the umbrella structure (FIG. 37c). The flat structure (FIG. 37a) transports water from a central vertical CCF channel to the top surface, and then flows towards two sides. The tapered structure (FIG. 37b) transports from the two wings to the center top. This structure is supported in the center by a plastic board without any wicking layers for water transportation. The umbrella structure (FIG. 37c) transports water from a central vertical CCF channel to the top surface, and then down through the two wings. This structure is supported in the center by a plastic board covered by CCF layers for vertical water transportation.

### S3: Calculation of Porosity of CCF

The porosity, Ø, of the carbon-coated fabric was determined based on the mass of the material before and after it was wet:

$$⌀ = \frac{\frac{{m}_{2} - {m}_{1}}{{ρ}_{2}}}{\frac{{m}_{1}}{{ρ}_{1}} + \frac{{m}_{2} - {m}_{1}}{{ρ}_{2}}} . \qquad ( 5 )$$

Here, m₁ and m₂ are the mass of the material before and after it was wet (i.e., 0.0100 g and 0.0693 g, respectively); ρ₁ is the density of the material (i.e., 341.6 kg m⁻³ for texwipe-609) and ρ₂ is the density of water (i.e., 1000 kg m⁻³). Therefore, the porosity, Ø, is calculated to be 66.9%.

### Additional Examples

Example 1. A solar vapor generation system, having: a substrate configured to wick solution from a reservoir, wherein the substrate comprises a first planar sheet at least a portion of which is configured to be in contact with the solution, and wherein the first planar sheet has a first end connected to a first end of a second planar sheet at an angle of between 1.0 and 90.0 degrees; and a support, configured to support the substrate above the solution.

Example 2. The solar vapor generation system of example 1, wherein the second planar sheet is configured to not directly contact the solution.

Example 3. The solar vapor generation system of any one of examples 1 or 2, wherein the first planar sheet and/or the second planar sheet comprise more than one layer.

Example 4. The solar vapor generation system of example 3, wherein the first planar sheet and/or the second planar sheet comprise more than five layers or more than ten layers.

Example 5. The solar vapor generation system of example 3, wherein each layer is made from a same material as each other layer.

Example 6. The solar vapor generation system of example 3, wherein at least one layer is made from a different material as at least one other layer.

Example 7. The solar vapor generation system of any one of examples 1 or 2, further comprising a non-wicking member disposed between the substrate and the support.

Example 8. The solar vapor generation system of example 2, further comprising a third planar sheet having a first end connected to the first end of the first planar sheet, wherein the third planar sheet is configured to not directly contact the solution, and wherein the second planar sheet and the third planar sheet are arranged on opposite sides of the first planar sheet from each other.

Example 9. The solar vapor generation system of example 8, wherein the angle between the first planar sheet and the second planar sheet is between 1.0 and 89.0 degrees, and wherein an angle between the first planar sheet and the third planar sheet is between 1.0 and 89.0 degrees.

Example 10. The solar vapor generation system of example 8, wherein the angle between the first planar sheet and the second planar sheet is less than 30 degrees, and wherein an angle between the first planar sheet and the third planar sheet is less than 30 degrees.

Example 11. The solar vapor generation system of any one of examples 1, 2, or 8-10, wherein the substrate is impregnated with carbon nanoparticles.

Example 12. The solar vapor generation system of example 11, wherein the density of carbon nanoparticles is between 0.01 and 0.1 g per cubic centimeter of substrate.

Example 13. The solar vapor generation system of example 11, wherein the density of carbon nanoparticles is between 0.05 and 0.8 g per cubic centimeter of substrate.

Example 14. The solar vapor generation system of any one of examples 1, 2, or 8-10, wherein the substrate comprises a porous material.

Example 15. The solar vapor generation system of any one of examples 1, 2, or 8-10, wherein the substrate comprises a fabric.

Example 16. The solar vapor generation system of example 15, wherein the substrate is a non-woven fabric.

Example 17. The solar vapor generation system of example 15, wherein the substrate is a woven fabric.

Example 18. The solar vapor generation system of any one of examples 1, 2, or 8-10, wherein the substrate comprises a cellulose/polyester blend, comprising 35% to 75% cellulose, and 25% to 65% polyester.

Example 19. The solar vapor generation system of example 18, wherein the blend comprises about 55% cellulose and about 45% polyester.

Example 20. The solar vapor generation system of any one of examples 1, 2, or 8-10, wherein the substrate consists essentially of cellulose.

Example 21. The solar vapor generation system of any one of examples 1, 2, or 8-10, further comprising an air mover configured to cause air to move across each of the first planar sheet, the second planar sheet, and the third planar sheet.

Example 22. The solar vapor generation system of any one of examples 1, 2, or 8-10, wherein a temperature of the substrate is maintained substantially at or below an ambient temperature.

Example 23. The solar vapor generation system of any one of examples 1, 2, or 8-10, further comprising a temperature-controlled housing for maintaining an ambient temperature above the substrate temperature.

Example 24. The solar vapor generation system of any one of examples 1, 2, or 8-10, wherein the support is a thermal insulator.

Example 25. The solar vapor generation system of any one of examples 1, 2, or 8-10, wherein the substrate is further treated to increase hydrophilicity.

Example 26. The solar vapor generation system of any one of examples 1, 2, or 8-10, wherein the substrate is treated with sodium alginate.

Example 27. The solar vapor generation system of any one of examples 1, 2, or 8-10, wherein the first planar sheet, the second planar sheet, and/or the third planar sheet comprise more than one layer.

Example 28. The solar vapor generation system of any one of examples 1, 2, or 8-10, wherein the first planar sheet, the second planar sheet, and/or the third planar sheet comprise more than five layers or more than ten layers.

Example 29. The solar vapor generation system of example 27, wherein each layer is made from a same material as each other layer.

Example 30. The solar vapor generation system of example 27, wherein at least one layer is made from a different material as at least one other layer.

Although the present disclosure has been described with respect to one or more particular embodiments, it will be understood that other embodiments of the present disclosure may be made without departing from the spirit and scope of the present disclosure.

What is claimed is:

1. A solar vapor generation system, comprising:
a substrate configured to wick solution from a reservoir, wherein the substrate comprises a first planar sheet at least a portion of which is configured to be in contact with the solution, and wherein the first planar sheet has a first end connected to a first end of a second planar sheet at an angle of between 1.0 and 90.0 degrees; and
a support, configured to support the substrate at a position above the solution.

2. The solar vapor generation system of claim 1, wherein the second planar sheet is configured to not directly contact the solution.

3. The solar vapor generation system of claim 1, wherein the first planar sheet and/or the second planar sheet comprise more than one layer.

4. The solar vapor generation system of claim 3, wherein the first planar sheet and/or the second planar sheet comprise more than five layers or more than ten layers.

5. The solar vapor generation system of claim 3, wherein each layer is made from a same material as each other layer.

6. The solar vapor generation system of claim 3, wherein at least one layer is made from a different material as at least one other layer.

7. The solar vapor generation system of claim 2, further comprising a non-wicking member disposed between the substrate and the support.

8. The solar vapor generation system of claim 2, further comprising a third planar sheet having a first end connected to the first end of the first planar sheet, wherein the third planar sheet is configured to not directly contact the solution, and wherein the second planar sheet and the third planar sheet are arranged on opposite sides of the first planar sheet from each other.

9. The solar vapor generation system of claim 8, wherein the angle between the first planar sheet and the second planar sheet is between 1.0 and 89.0 degrees, and wherein an angle between the first planar sheet and the third planar sheet is between 1.0 and 89.0 degrees.

10. The solar vapor generation system of claim 8, wherein the angle between the first planar sheet and the second planar sheet is less than 30 degrees, and wherein an angle between the first planar sheet and the third planar sheet is less than 30 degrees.

11. The solar vapor generation system of claim 8, wherein the substrate is impregnated with carbon nanoparticles.

12. The solar vapor generation system of claim 11, wherein the density of carbon nanoparticles is between 0.01 and 0.1 g per cubic centimeter of substrate.

13. The solar vapor generation system of claim 11, wherein the density of carbon nanoparticles is between 0.05 and 0.8 g per cubic centimeter of substrate.

14. The solar vapor generation system of claim 8, wherein the substrate comprises a porous material.

15. The solar vapor generation system of claim 8, wherein the substrate comprises a fabric.

16. The solar vapor generation system of claim 15, wherein the substrate is a non-woven fabric.

17. The solar vapor generation system of claim 15, wherein the substrate is a woven fabric.

18. The solar vapor generation system of claim 8, wherein the substrate comprises a cellulose/polyester blend, comprising 35% to 75% cellulose, and 25% to 65% polyester.

19. The solar vapor generation system of claim 18, wherein the blend comprises about 55% cellulose and about 45% polyester.

20. The solar vapor generation system of claim 8, wherein the substrate consists essentially of cellulose.

21. The solar vapor generation system of claim 8, further comprising an air mover configured to cause air to move across each of the first planar sheet, the second planar sheet, and the third planar sheet.

22. The solar vapor generation system of claim 8, wherein a temperature of the substrate is maintained substantially at or below an ambient temperature.

23. The solar vapor generation system of claim 8, further comprising a temperature-controlled housing for maintaining an ambient temperature above the substrate temperature.

24. The solar vapor generation system of claim 8, wherein the support is a thermal insulator.

25. The solar vapor generation system of claim 8, wherein the substrate is further treated to increase hydrophilicity.

26. The solar vapor generation system of claim 25, wherein the substrate is treated with sodium alginate.

27. The solar vapor generation system of claim 8, wherein the first planar sheet, the second planar sheet, and/or the third planar sheet comprise more than one layer.

28. The solar vapor generation system of claim 8, wherein the first planar sheet, the second planar sheet, and/or the third planar sheet comprise more than five layers or more than ten layers.

29. The solar vapor generation system of claim 27, wherein each layer is made from a same material as each other layer.

30. The solar vapor generation system of claim 27, wherein at least one layer is made from a different material as at least one other layer.
